(19) United States
(12) Patent Application Publication
(10) Pub. No.: US 2013/0304639 A1
(43) Pub. Date: Nov. 14, 2013

(54) METHODS AND SYSTEMS FOR GLOBAL INVOICE PROCESSING AND PAYMENT

(71) Applicants: Kimberly Ann Acsay, Florissant, MO (US); Jeffrey James Hopkins, Dittmer, MO (US); Conrad John Pawlowski, II, Cottleville, MO (US); Karen Marie Reeves, O'Fallon, MO (US); Celeste Elizabeth Sauer, Bridgeton, MO (US)

(72) Inventors: Kimberly Ann Acsay, Florissant, MO (US); Jeffrey James Hopkins, Dittmer, MO (US); Conrad John Pawlowski, II, Cottleville, MO (US); Karen Marie Reeves, O'Fallon, MO (US); Celeste Elizabeth Sauer, Bridgeton, MO (US)

(21) Appl. No.: 13/467,827

(22) Filed: May 9, 2012

(51) Int. Cl. G06Q 40/00

(52) U.S. Cl. 705/40

(57) ABSTRACT

A computer based method and system for managing payments from a shipper to one or more carriers is described. A web-based interface portal is accessible by a shipper, one or more carriers and an invoice payment service provider to enable data relevant to various characteristics of a shipment of goods to be uploaded into a database. One or more profiles are created with the data to enable a specified shipment to be rated, to enable a carrier's actual invoice for a specified shipment to be compared with a rated invoice for that specified shipment to identify discrepancies between the rated and actual invoices.

### BACKGROUND OF THE INVENTION

The embodiments described herein relate generally to methods and systems for paying invoices, and more specifically to the payment, by a third party contracted by a shipper, of carriers' invoices for shipment services provided to that shipper.

A business which provides services and or products may incur expenses from a wide variety of sources. Invoices, also referred to as bills, are issued by those sources to document the services or products provided and to request payment. The business may not have the resources (manpower, equipment, etc.) to review and pay the invoices, or may wish to concentrate its focus on the actual provision of the services and/or products which make up its core business. For those and other reasons, the business may employ the services of an invoice payment service provider.

An invoice payment service provider may be tasked with the intake, review and analysis of a customer's invoices for a wide variety of expenses. One example of such an expense may be the shipping fees that a customer incurs for delivering products to intermediate recipients or end users. Other shipping fees may be incurred for the delivery of raw materials or partially manufactured goods to the customer for conversion into further partially or fully finished products.

Typically, a shipper and carrier agree to shipping terms before shipment is made and those terms are documented in an agreement or contract. In order to attend to the payment of such shipping expenses, an invoice payment service provider must review carriers' invoices and analyze them for conformity with the terms of the agreement or contract. For example, each invoice received from a carrier is analyzed to ensure that all requirements and conditions set by the shipper for the particular delivery have been met by the carrier, as an initial threshold which must be met before payment of the invoice can be approved.

In addition, if there are discrepancies between the fees charged in the carrier's invoice and the previously agreed-upon terms, the invoice payment service provider must be able to resolve those discrepancies as well.

The process of resolving discrepancies may vary depending on the home country of the carrier, the origin of the shipment and/or the destination of the shipment. Sometimes, additional documentation or a “final” invoice is required in order to resolve an issue, in particular when the invoice processing is being handled electronically. However, some countries do not allow physical invoices to leave their borders. Also, in some countries (such as the United States), a shipper may be able to pay to a carrier the amount the shipper believes to be the correct amount owed to a carrier, regardless of the actual amount stated in the invoice. However, in other countries, such an option is not available to the shipper (or its payment service provider) and any discrepancies between the carrier's initial invoice and the agreed-to terms must be resolved before a final invoice can be generated and payment can be made.

In addition, an invoice payment service provider must be able to obtain accurate invoices from the various carriers, regardless of where the carrier is located and/or, the origin or destination of the shipment(s) covered by that invoice. The ability of an invoice payment service provider to obtain copies or originals of carrier invoices may be impacted by the location of the carrier, or the origin or destination points of the shipment(s) involved.

Complications may occur during shipping of a product. Billing terms corresponding to those complications may be included within the contract. For example, delays in completing a shipment, discrepancies between the shipment conditions agreed to and those actually provided, or discrepancies between a previously-agreed to price and a carrier's “final” invoice cause the invoice to deviate from the basic terms of the contract and invoke alternative terms within the contract. In those situations, significant human interaction may be required, often of both parties, and often of third parties as well, in order to enable those discrepancies to be resolved to the satisfaction of all parties involved and payment of a truly final invoice for that shipment or shipments (if a combined invoice is involved).

It would be desirable to provide a web-based invoice resolution method and system which can address and fulfill legal and business requirements for invoicing practices, by applying location-dependent rules (i.e., addressing country-specific laws and regulations, such as with respect to the handling and issuance of final invoices), particularly with regard to the intake, processing and payment of invoices, and specifically, shipping invoices.

It would also be desirable to provide a method and system for the intake, processing, and payment of invoices, and specifically, shipping invoices, which results in a reduction in the reliance on the exchange and handling of physical paper documents, and on the need for human intervention in resolving disputes and discrepancies between previously-agreed upon terms and subsequent carrier invoices.

### BRIEF DESCRIPTION OF THE INVENTION

In an aspect, a computer based method for processing and paying invoices from one or more carriers on behalf of a shipper is provided. The computer based method comprises creating at least one data profile based on data provided by at least one of the shipper, the carrier and the invoice payment service provider wherein the data provided by at least one of the shipper, the carrier and the invoice payment service provider comprises country-specific data representing requirements regulating shipping. The method further comprises creating a rating for a specified shipment of goods based at least partially on the at least one data profile, the rating representing an optimized set of one or more charges for the specified shipment of goods. The method further comprises receiving an actual invoice corresponding to the specified shipment of goods from the carrier. The method further comprises the rating to data included within the actual invoice for the specified shipment of goods. The method further comprises identifying whether any discrepancies exist between the rating and the data included within the actual invoice.

In another aspect, a system for processing and paying invoices from one or more carriers on behalf of a shipper is provided. The system comprises a database configured to store data associated with at least one of a shipper, a carrier and an invoice payment service provider; a database server; and one or more computers. The database, database server, and one or more computers are configured to create at least one data profile based on data provided by at least one of a shipper, one or more carriers and an invoice payment service provider wherein the data provided by at least one of a shipper, one or more carriers and an invoice payment service provider comprises country-specific data representing requirements regulating shipping. The database, database server, and one or more computers are further configured to create a rating for a specified shipment of goods, the rating representing an optimized set of one or more charges for the specified shipment of goods. The database, database server, and one or more computers are further configured to receive an actual invoice corresponding to the specified shipment of goods from the carrier. The database, database server, and one or more computers are configured to compare the rating to data included within the actual invoice for the specified shipment of goods. The database, database server, and one or more computers are further configured to identify whether any discrepancies exist between the rating and the data included within the actual invoice.

In a further aspect, a computer device for processing and paying invoices from one or more carriers on behalf of a shipper is provided in which the computer device is programmed to create at least one data profile based on data provided by at least one of the shipper, the carrier and the invoice payment service provider wherein the data provided by at least one of the shipper, the carrier and the invoice payment service provider comprises country-specific data representing requirements regulating shipping. The computer device is further programmed to create a rating for a specified shipment of goods based at least partially on the at least one data profile, the rating representing an optimized set of one or more charges for the specified shipment of goods. The computer device is further programmed to receive an actual invoice corresponding to the specified shipment of goods from the carrier. The computer device is further programmed to compare the rating to data included within the actual invoice for the specified shipment of goods. The computer device is further programmed to identify whether any discrepancies exist between the rating and the data included within the actual invoice.

### BRIEF DESCRIPTION OF THE DRAWINGS

FIG. 1 is a schematic illustration of an exemplary global invoice processing and payment system, illustrating the paths of communication between a shipper, a plurality of carriers providing shipping services for the shipper, and an invoice payment service provider.

FIG. 2 is a simplified block diagram of an exemplary invoice payment system infrastructure in accordance with one embodiment of the present invention.

FIG. 3 is an expanded block diagram of exemplary server architecture of the invoice payment system shown in FIG. 2.

FIG. 4 illustrates an exemplary configuration of a user computing device shown in FIGS. 2 and 3.

FIG. 5 illustrates an exemplary configuration of a server computing device as shown in FIGS. 2 and 3.

FIG. 6 is a flowchart illustrating an exemplary invoice management process that may be performed by the invoice management systems shown in FIGS. 2 and 3.

FIG. 7 is a flowchart illustrating an exemplary data acquisition stage of the invoice management process shown in FIG. 6 that may be performed using the systems shown in FIGS. 2 and 3.

FIG. 8 is a flowchart illustrating an exemplary invoice processing stage of the invoice management process shown in FIG. 6 that may be performed using the systems shown in FIGS. 2 and 3.

FIG. 9 is a flowchart illustrating an exemplary payment processing stage of the invoice management process shown in FIG. 6 that may be performed using the systems shown in FIGS. 2 and 3.

FIG. 10 is a flowchart illustrating an exemplary post-payment stage of the invoice management process shown in FIG. 6 that may be performed using the systems shown in FIGS. 2 and 3.

FIG. 11 is a flowchart illustrating an exemplary profile creation stage of the invoice management process shown in FIG. 6 that may be performed using the systems shown in FIGS. 2 and 3.

FIG. 12 is a flowchart illustrating an exemplary audit processing stage of the invoice management process shown in FIG. 6 that may be performed using the systems shown in FIGS. 2 and 3.

FIG. 13 is a flowchart illustrating an exemplary invoice e-billing stage of the invoice management process shown in FIG. 6 that may be performed using the systems shown in FIGS. 2 and 3.

FIG. 14 is a flowchart illustrating a shipper's invoice accrual rating stage for the invoice management process shown in FIG. 6 that may be performed using the systems shown in FIGS. 2 and 3.

FIG. 15 is a flowchart illustrating an exemplary invoice rating stage for rating invoices based on carrier data, for the invoice management process shown in FIG. 6 that may be performed using the systems shown in FIGS. 2 and 3.

FIG. 16 is a flowchart illustrating an exemplary invoice collaboration and resolution procedure of the invoice management process shown in FIG. 6, which may be performed using the systems shown in FIGS. 2 and 3.

### DETAILED DESCRIPTION OF THE INVENTION

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

The methods and systems described herein facilitate auditing, reconciliation, and payment of invoices by an invoice payment service provider (“IPSP”). For example, the IPSP will establish a web-based portal or interface, through which shippers and carriers can access records pertaining to their matters and can upload and download data, reports, pre- and final invoices, etc. An invoice payment system may, in an exemplary embodiment, be configured such that employees of the IPSP may access the same portal, for purposes of data entry and retrieval, invoice processing, and communications with shippers, carriers and other third parties, via an intranet arrangement.

The methods and systems described herein also facilitate application of shipper-specific and/or shipment-specific rules to the invoice review process. For example, the invoice payment service may be provided through the use of a profile-based program, in which a series of shipper profiles are employed. Each profile will include a set of rules or operating parameters which will control or direct how an invoice is handled. For example, a shipper profile may include rules such as what the permissible tolerances are for specific dollar amounts for various types of charges that may appear on a carrier's invoice, whether specific approval from a shipper must be obtained when out-of-tolerance charges are encountered, whether payment of an invoice requires that all or certain items of shipper's data regarding a shipment and carrier's data regarding that same shipment match, what the required conditions of the shipment (type of delivery, such as overnight, etc.) are, and so forth.

Another example of a requirement that may be included in a shipper profile is whether the shipper has what may be referred to as a MATCHPAY™ account. MATCHPAY™ is a trademark of Cass Information Systems of St. Louis, Mo. In a MATCHPAY™ account, in order for a carrier's invoice to be approved for payment, all or a predefined portion, of certain data received from a shipper, regarding a specific shipment, and corresponding data received from a carrier, regarding that same shipment, must match. Data of this type is referred to herein as “match data.”

Typically, once a profile or set of profiles has been created for a shipper, changes will only be made to a shipper's profile or profiles if data is found to be missing, incorrect, or has been changed, for example upon direction of the shipper

As a shipper profile is created, for example, by an employee of the IPSP, the employee may be required to enter and/or confirm certain data, and/or responses to inquiries prompted by the invoice management system. Creation of the profile will occur through, e.g., the employee accessing a web- or intranet-based online facility, acting as a portal to the invoice management system. The fields in each profile may be configured to be self-populating (e.g., triggered based on data in other fields), or may be populated by direct input of data, selection from drop-down menus, etc. The underlying software will be suitably programmed to access and acquire data from various databases maintained by the IPSP, the shipper, the carrier(s) or third parties outside of the invoice management system, in order to resolve a discrepancy and/or complete payment of an invoice. By comparing the data acquired from various databases, as triggered by the rules present in a shipper's specific profile, discrepancies can be identified, such as differences between previously-agreed upon charges and charges actually presented by the carrier. In addition to identifying discrepancies, data in certain fields may trigger certain warnings or identify where a numerical value exceeds a predetermined limit, such as those imposed by applicable local rules or regulations.

To set up a shipper's “profile” a user encounters a series of screens on their display, each screen containing a number of fields into which data is input by the user or another party, acquired from one of a number of stored databases and/or generated as a result of the nature of other data present in other fields in that specific profile or other profiles that have been configured to “interact” with that profile. A single shipper may have a number of profiles assigned to it, for example if the shipper is a corporation with multiple divisions, each division may have its own profile, with its own requirements for enabling a shipment invoice to be approved for payment.

In addition, the methods and systems described herein provide warnings and feedback to an operator, when invalid entries are attempted by an operator. Moreover, the profile tabs are provided with mechanisms to require validation of data being input by an operator, prior to final confirmation. These are examples of the functionalities with which the IPSP's processing system may be provided, but it is not intended to be limiting or exhaustive.

A technical effect of the systems and processes described herein include at least one of: (a) creating, by operators of the IPSP, a plurality of profiles using data from at least one of shippers, carriers, country-specific rules and regulations concerning the shipment of goods and materials both domestically and internationally with respect to those countries, and/or other third party databases; (b) receiving invoices from one or more carriers for shipments made or arranged by the carriers on behalf of a shipper; (c) rating an invoice to determine an idealized correct invoice for the specific terms and conditions of a specific shipment; (d) reviewing and analyzing the invoices received by the IPSP from the carriers to determine whether the invoice dollar amounts and/or other conditions of a shipment deviate from terms and conditions for the shipment that were previously agreed-upon between the shipper and the one or more carriers; (e) instigating collaboration between two or more of the shipper, one or more carriers, and/or the IPSP to resolve discrepancies between a rated invoice and an actual invoice received from a carrier to enable a payment to a carrier to be made; (f) sending billing instructions to a carrier after any invoice discrepancies have been resolved, to enable a carrier to create and upload a final invoice to the IPSP, as may be required under applicable local law; (g) electronically requesting funds from a shipper to enable the IPSP to make payments to one or more carriers; and (h) generating and transmitting periodic reports to shippers to inform them of the status of shipments and payments being made on the shipper's behalf.

As employed herein, the term “collaboration” refers to interaction between an IPSP, a shipper, a carrier, and/or one or more third parties to resolve a discrepancy or discrepancies that are encountered between, e.g., data supplied by a carrier regarding a particular shipment, data supplied by a shipper regarding a particular shipment, and/or previously agreed-to terms regarding an aspect of a particular shipment. “Audit collaboration” and “Audit Resolution”, and “invoice collaboration” and “Invoice Resolution”, as used herein refer, respectively, to specific processes and their corresponding user interfaces accessible by users to access and/or modify data relating to a shipment and corresponding invoice at the web-based utility maintained by IPSP to enable specific data-related issues to be addressed. Audit collaboration enables access to shipment/invoice data by IPSP auditing personnel specifically, while invoice collaboration enables access to data for all users, such as shippers, carriers, and other IPSP personnel.

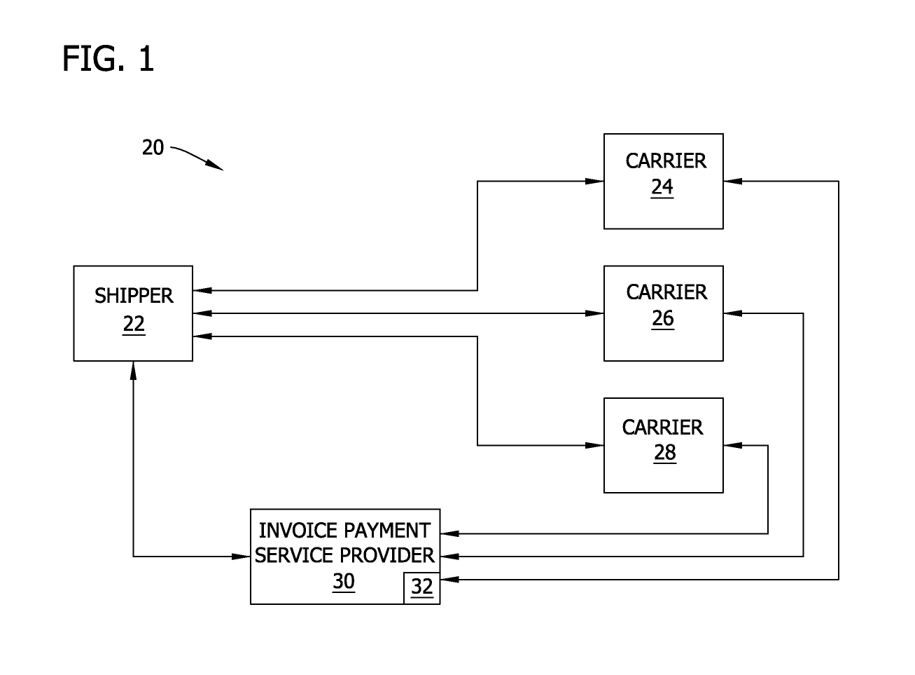

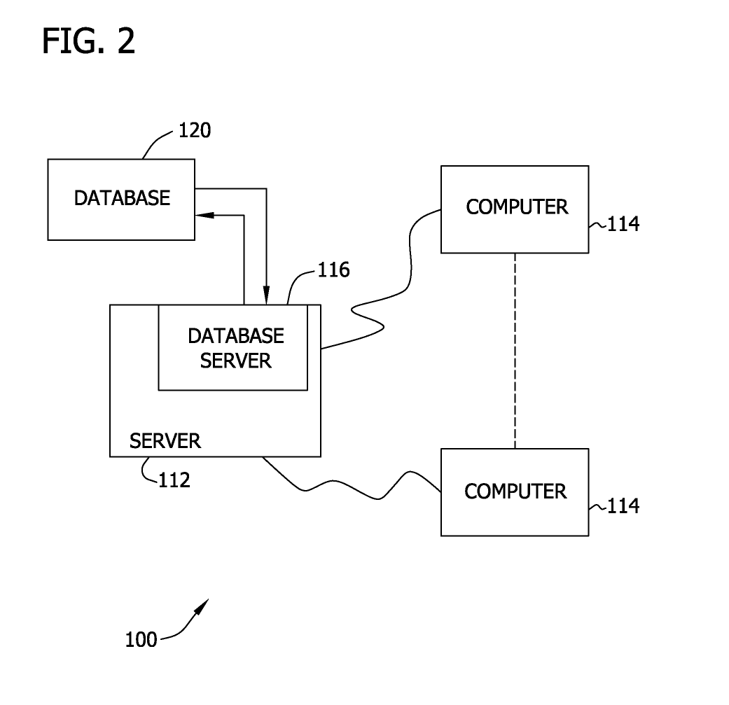

FIG. 1 is a block diagram of an exemplary global invoice processing and payment system 20. In the exemplary embodiment, system 20 includes a shipper 22, a plurality of carriers 24, 26, 28, and an invoice payment service provider (IPSP) 30. While, as an example, three carriers 24, 26 and 28 are shown in FIG. 2, a greater or lesser number of carriers may be included in system 20.

In the exemplary embodiment, each of shipper 22, carriers 24, 26 and 28, and IPSP 30 are in two-way communication with each other, with such communication being provided by internet and/or telephonic connections, among other possible communication sources. In the exemplary embodiment, IPSP 30 includes an invoice management system 32 configured to perform the processes described herein. Furthermore, in the exemplary embodiment, IPSP 30 is a separate entity from shipper 22, that is, a third-party who provides invoice management services. In an alternative embodiment, the functions of IPSP 30 and invoice management system 32 are included within, and performed by, shipper 22. For example, invoice management system 32 may be maintained and operated by IPSP 30, and incorporate infrastructure 100 (FIG. 2), configured to perform the methods and processes described herein. In the exemplary embodiment, data and physical document acquisition and analysis functions are performed by IPSP 30, in addition to an actual invoice payment function. In alternative embodiments, one or more of these functions may be performed by third parties other than IPSP 30. In addition, although illustrated as having three carriers, payment system 20 may include any number of carriers and invoice management system 32 may be configured to address invoices from any suitable number of carriers that allows system 20 to function as described herein.

FIG. 2 is a simplified block diagram of an exemplary infrastructure 100 used by system 32 in accordance with one embodiment of the present invention. In one embodiment, infrastructure 100 is a global invoice management system, for example, invoice management system 32, used to facilitate processing and payment, by IPSP 30, of invoices from carriers 24, 26 and 28, for shipping and related services provided to shipper 22.

More specifically, in the exemplary embodiment, infrastructure 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems and special high-speed ISDN lines. Client systems 114 could be any devices capable of interconnecting to the Internet including a web-based phone, personal digital assistant (PDA), or other web-based connectable equipment. A database server 116 is connected to database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 stores data relating to the details of a shipper's business, such as details and requirements associated with agreements and contracts shipper 22 may have with carriers 24, 26 and 28. In addition, database 120 can also be used to store data pertaining to individual shipment transactions (origin/destination points, special conditions required by the shipper, estimated or set critical dates for pickup and delivery, etc.). The foregoing are intended to be examples of the types of data stored in database 120, and are not intended to be exhaustive or limiting.

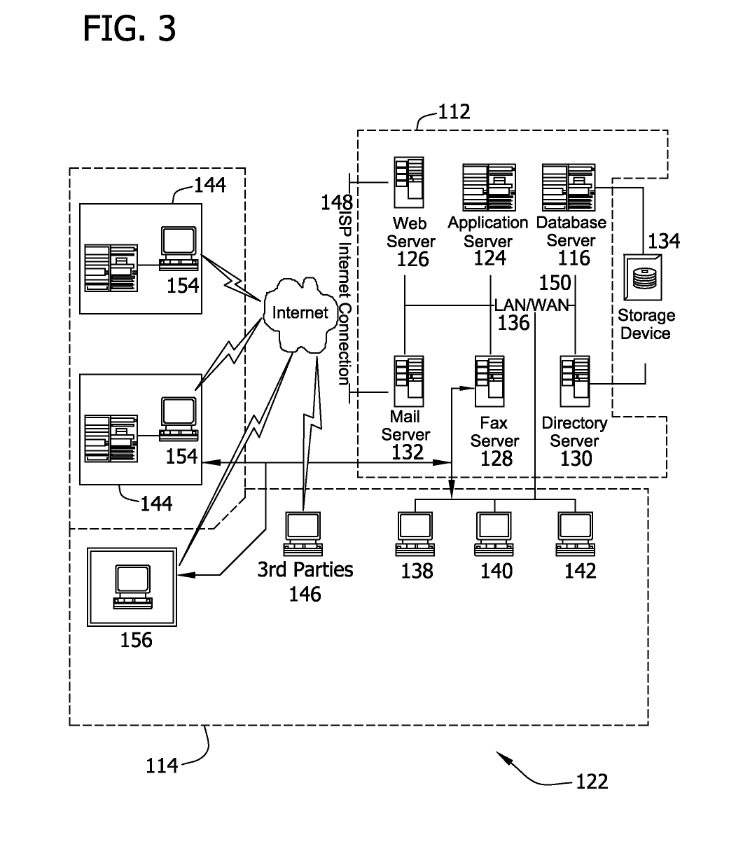

FIG. 3 is an expanded block diagram of an exemplary embodiment of server architecture of a system 122 in accordance with one embodiment of the present invention. Components in system 122, identical to components of infrastructure 100 (shown in FIG. 2), are identified in FIG. 3 using the same reference numerals as used in FIG. 2. System 122 includes server system 112 and client systems 114. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each of workstations, 138, 140, and 142 may be any computing device that includes a web browser, for example, but not limited to, a personal computer, a laptop, a tablet computer and/or a mobile phone. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., shipper 22, and carriers 24, 26, and 28, etc. (collectively, 3^{rd} parties 146), using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

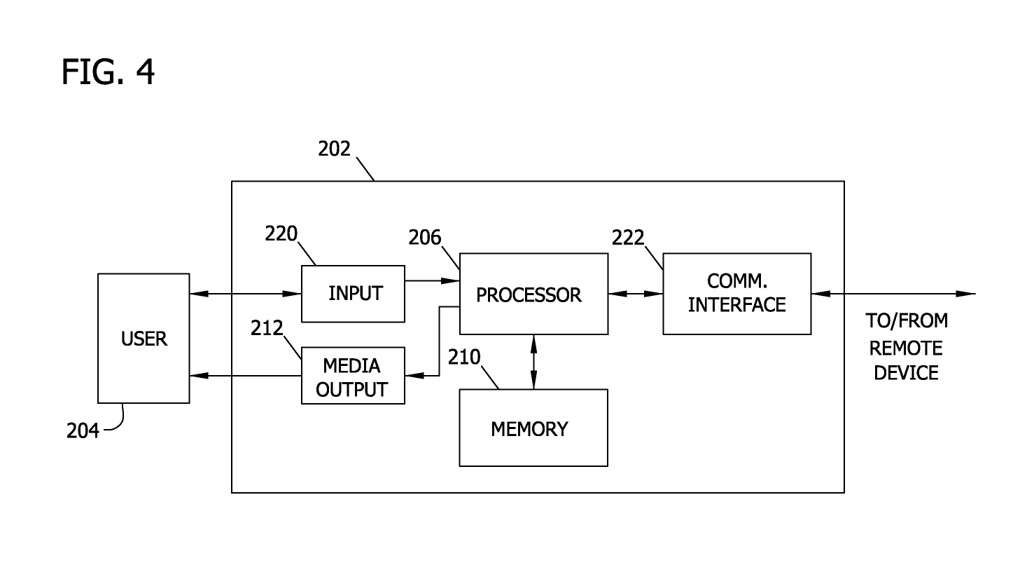

FIG. 4 illustrates an exemplary configuration of a user computing device 202 operated by a user 204. User computing device 202 may include, but is not limited to, client systems 114, 138, 140, and 142, workstation 154, and manager workstation 156.

User computing device 202 includes a processor 206 for executing instructions. In some embodiments, executable instructions are stored in a memory area 210. Processor 206 may include one or more processing units (e.g., in a multi-core configuration). Memory area 210 is any device allowing information such as executable instructions and/or written works to be stored and retrieved. Memory area 210 may include one or more computer readable media.

User computing device 202 also includes at least one media output component 212 for presenting information to user 204. Media output component 212 is any component capable of conveying information to user 204. In some embodiments, media output component 212 includes an output adapter such as a video adapter and/or an audio adapter. An output adapter is operatively coupled to processor 206 and operatively couplable to an output device such as a display device (e.g., a liquid crystal display (LCD), organic light emitting diode (OLED) display, or “electronic ink” display) or an audio output device (e.g., a speaker or headphones).

In some embodiments, user computing device 202 includes an input device 220 for receiving input from user 204. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 212 and input device 220.

User computing device 202 may also include a communication interface 222, which is communicatively couplable to a remote device such as server system 112. Communication interface 222 may include, for example, a wired or wireless network adapter or a wireless data transceiver for use with a mobile phone network (e.g., Global System for Mobile communications (GSM), 3G, 4G) or other mobile data network (e.g., Worldwide Interoperability for Microwave Access (WIMAX)).

Stored in memory area 210 are, for example, computer readable instructions for providing a user interface to user 204 via media output component 212 and, optionally, receiving and processing input from input device 220. A user interface may include, among other possibilities, a web browser and client application. Web browsers enable users, such as user 204, to display and interact with media and other information typically embedded on a web page or a website from server system 112. A client application allows user 204 to interact with a server application from server system 112.

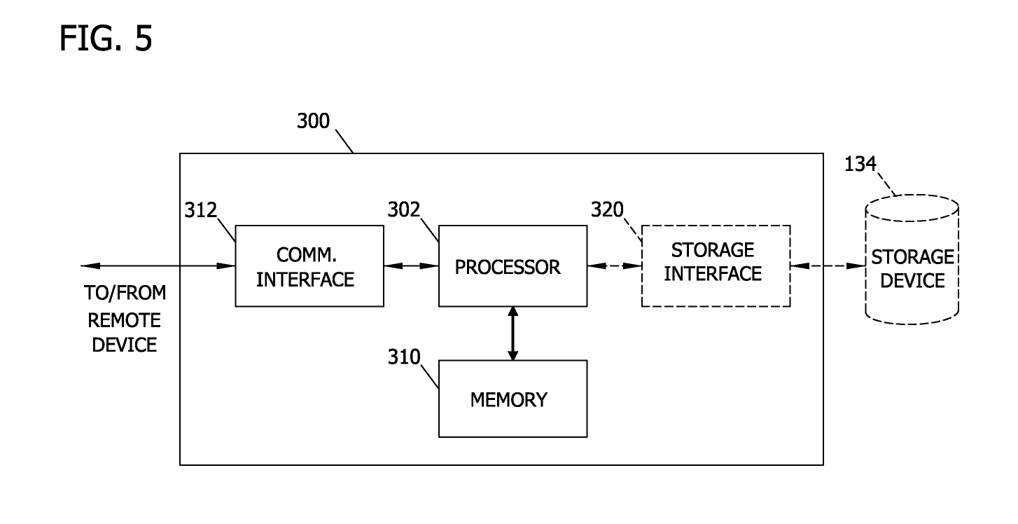

FIG. 5 illustrates an exemplary configuration of a server computing device 300 such as may be used in server system 112 (shown in FIG. 2). Server computing device 300 may include, but is not limited to, database server 116, application server 124, web server 126, fax server 128, directory server 130, and mail server 132.

Server computing device 300 also includes a processor 302 for executing instructions. Instructions may be stored in a memory area 310, for example. Processor 302 may include one or more processing units (e.g., in a multi-core configuration).

Processor 302 is operatively coupled to a communication interface 312 such that server computing device 300 is capable of communicating with a remote device such as user computing device 202 or another server computing device 300. For example, communication interface 312 may receive requests from user computing device 114 via the Internet, as illustrated in FIG. 3.

Processor 302 may also be operatively coupled to a storage device 134. Storage device 134 is any computer-operated hardware suitable for storing and/or retrieving data. In some embodiments, storage device 134 is integrated in server computing device 300. For example, server computing device 300 may include one or more hard disk drives as storage device 134. In other embodiments, storage device 134 is external to server computing device 300 and may be accessed by a plurality of server computing devices 300. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 302 is operatively coupled to storage device 134 via a storage interface 320. Storage interface 320 is any component capable of providing processor 302 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to storage device 134.

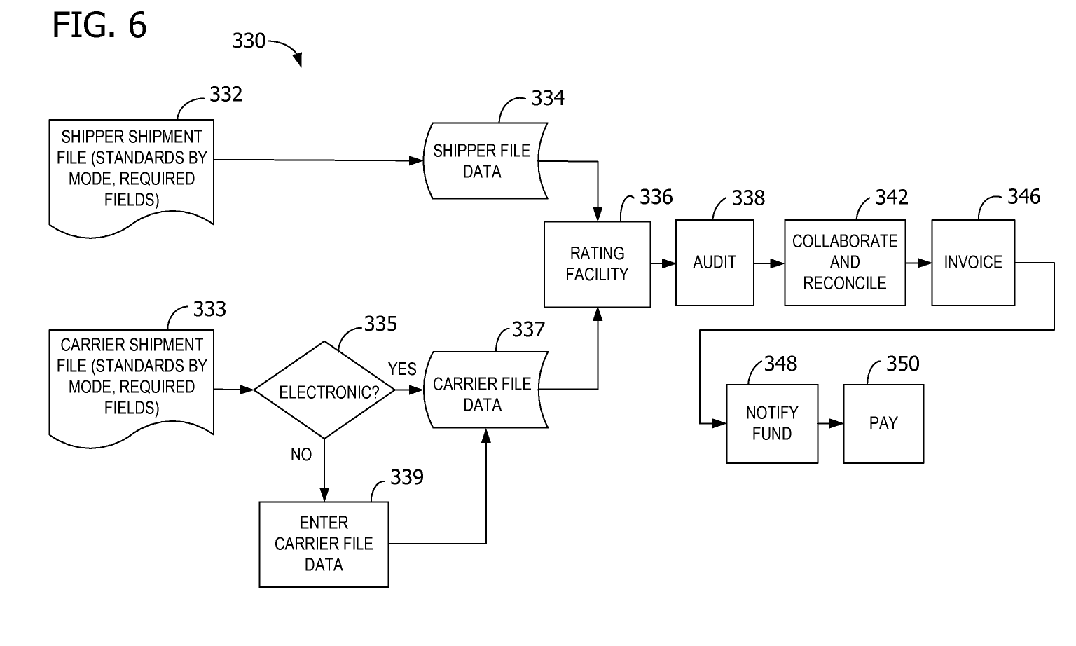

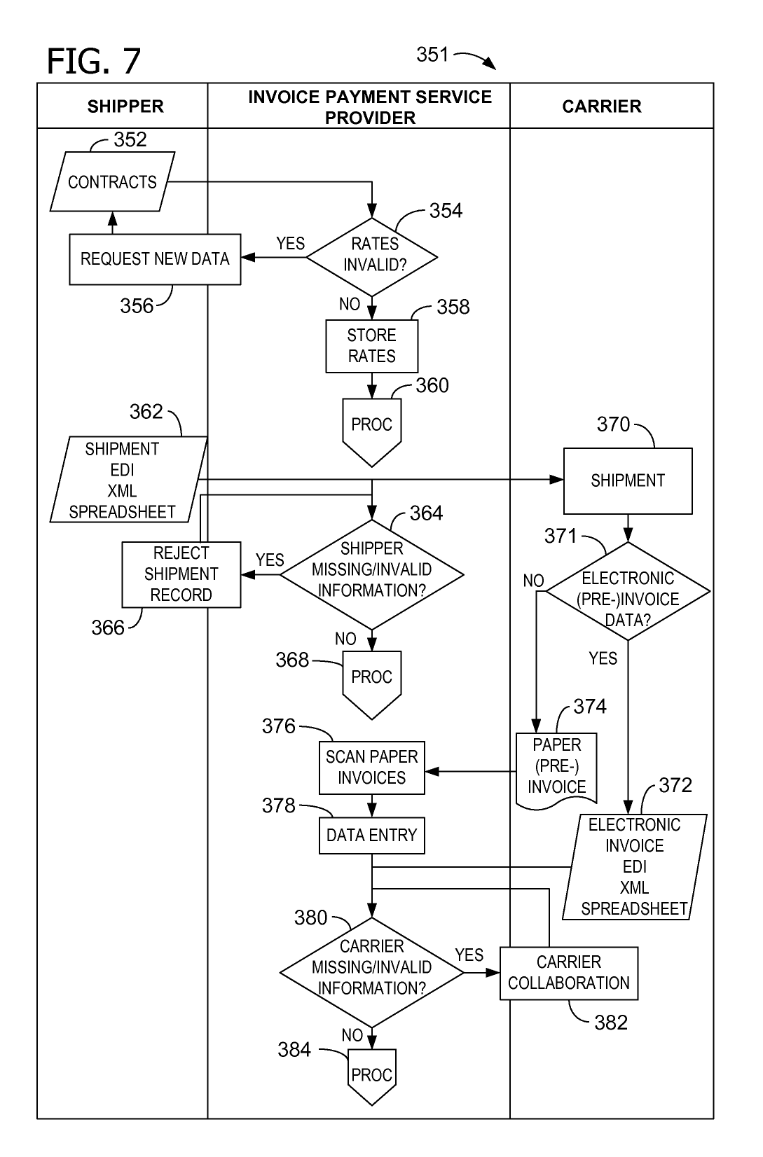

FIG. 6 is a schematic flow chart illustrating an exemplary overall process 330 for establishing and implementing a global invoice processing and payment system. FIGS. 7-16, discussed in detail herein, illustrate particular stages or phases of overall process 330. In the exemplary embodiment, an invoice management system, for example, system 32 (shown in FIG. 2) and/or system 122 (shown in FIG. 3), is configured to perform process 330.

In the exemplary embodiment, process 330 includes receiving 332 a shipment file from a new shipper, for example shipper 22 (shown in FIG. 1). As described above, shipper 22 is a customer of invoice payment service provider (IPSP) 30. Invoice payment service provider (IPSP) 30 creates a new account associated with shipper 22 from data provided by shipper 22. In the exemplary embodiment, one or more shipper profiles (not shown) will already exist for shipper 22, having been created at the time shipper 22 became a client of IPSP 30. For example, as previously discussed herein, shipper 22 may have different profiles for different divisions of shipper 22. In addition, or alternatively, shipper 22 may have different profiles based on different shipment modes (air, road, rail, sea), which profiles incorporate different sets of rules regulating the types of shipment data that must be required in order to create a shipment file. A shipment file includes data associated with a specific shipment requested by shipper 22. Preferably, the data is in electronic format and is transferred to IPSP 30 via one or more of a number of customary electronic data transfer mechanisms. In the exemplary embodiment, IPSP 30 enters 334 shipper file data associated with one or more shipments identified by shipper 22. The types of data that are entered as part of a particular shipment file may include logistical data, such as address(es) for shipper's location(s), identifications of the kinds of materials and/or goods being shipped.

IPSP 30 also receives and/or gathers 333 data from a carrier, for example, carrier 24 (shown in FIG. 1), to be included within a shipment file in a database, for example, database 120 (shown in FIG. 2). In the example of FIG. 6, carrier 24 creates 333 a carrier shipment file containing data from carrier 24 regarding a specific shipment. IPSP enters 337 carrier shipment data from the carrier shipment file submitted by carrier 24. Carrier data includes information such as, but not limited to, carrier location, modes of transportation, rates, descriptions and classifications of goods transported, package dimension and weight information, origin and destination information, special charges, financial and banking information such as currency of transaction, etc. If system 32 determines 335 that carrier data is missing and/or is not in electronic format, system 32 prompts IPSP 30 to acquire and manually enter 339 missing/paper carrier data into database 120.

In the exemplary embodiment, process 330 includes developing 336 a set of rate data. For example, data from both the shipper file data and the carrier file data is entered into a program, which is configured to develop a set of rate data, which represents a “correct” amount or amounts that would, in the absence of any discrepancies, be present in a “correct” invoice for the particular shipment in question. Rating facility programs for calculating a “rated” invoice are known, with one such program being used and marketed under the trademark RATEMAKER® by Cass Information Systems, Inc. of St. Louis, Mo.

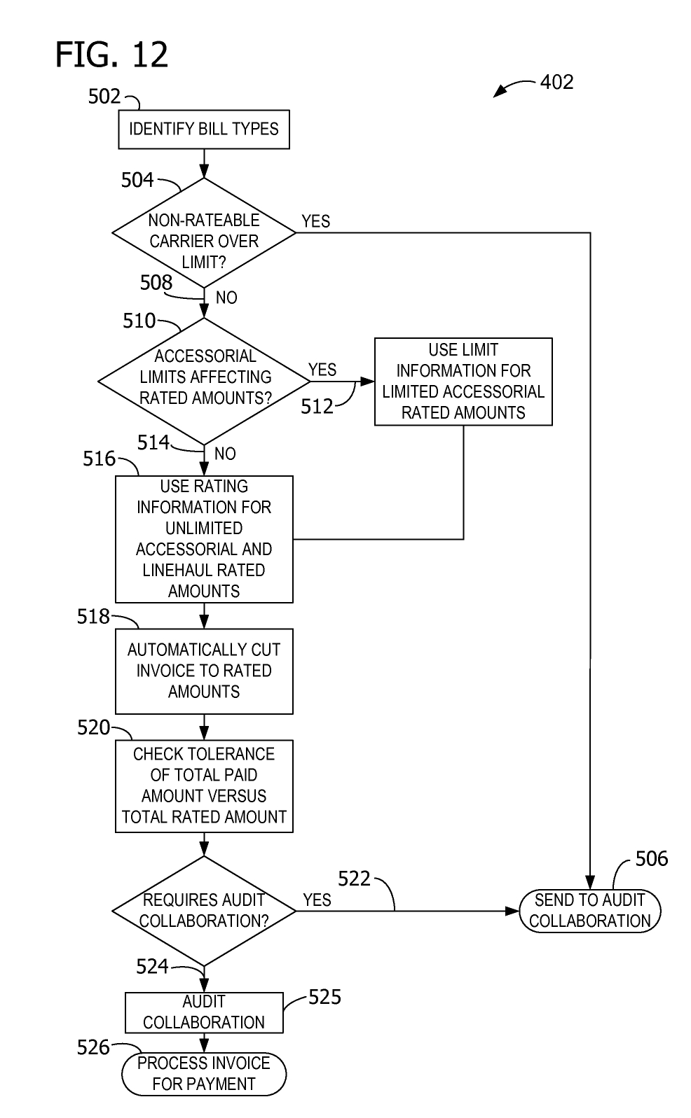

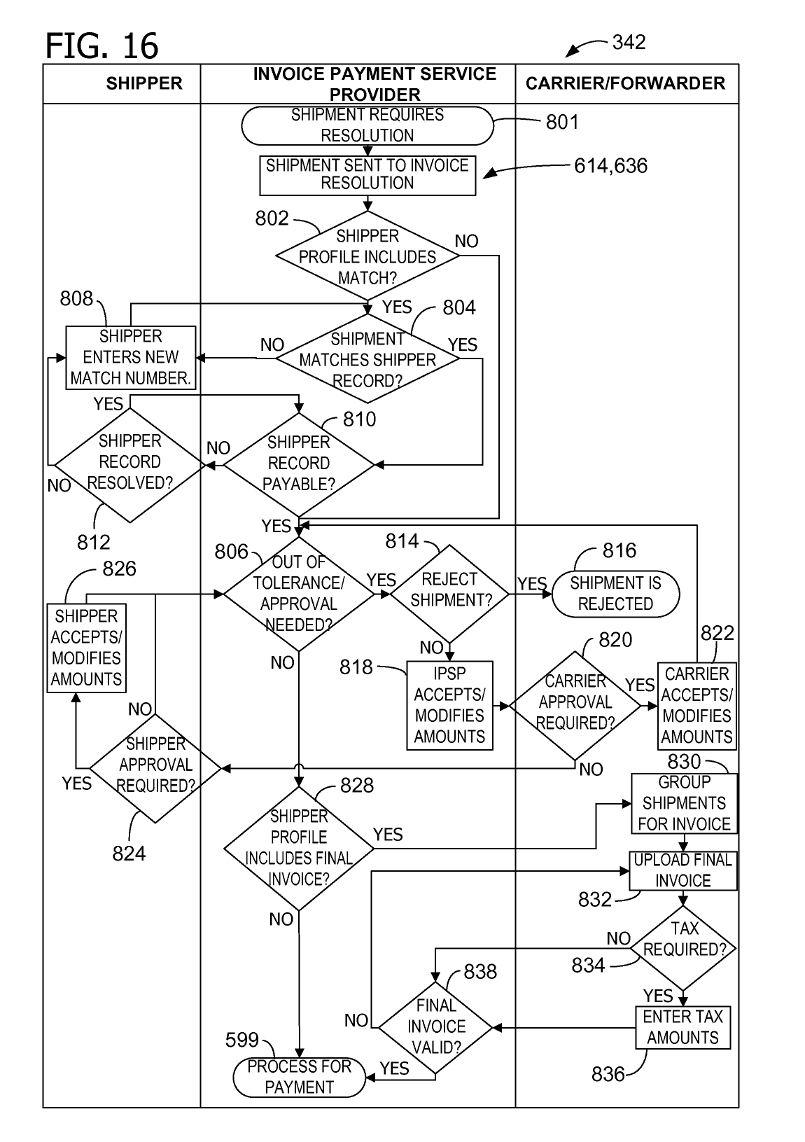

Once a rated invoice has been generated, it is audited 338, line for line, against the actual invoice presented by carrier 24 for the shipment in question. If the rated invoice and the actual invoice from the carrier 24 are identical, then the actual invoice is processed for payment (see FIG. 12). If, however, discrepancies between the rated invoice and the actual invoice are uncovered as a result of the audit process 338, then the actual invoice is forwarded to a collaboration and reconciliation process 342, during which discrepancies are resolved to bring the invoice into conformity with terms previously agreed-upon by shipper 22 and carrier 24, and/or to generate a new invoice incorporating revised terms mutually satisfactory to both shipper 22 and carrier 24. Invoice collaboration and reconciliation/resolution process 342 is shown in further detail in, and described with respect to, FIG. 16. In the exemplary embodiment, invoice management system 32 generates 346 a final invoice, based on at least one of the actual invoice and the new invoice, and notifies 348 shipper 22 of the amount due to carrier 24 for that particular shipment. Shipper 22 then transfers funds to IPSP 30, and IPSP 30 then transfers 350 funds to carrier 24.

While FIG. 6, as just described, illustrates the overall invoice payment process 330, certain stages of process 330 merit further discussion. For example, before any invoices for a shipper 22 can be processed and paid, an account must be set up for shipper 22, and various categories of data acquired from shipper 22, carrier 24, as well as from third-party sources.

FIG. 7 is a flowchart depicting an exemplary method 351 for acquiring data necessary for the processing of an invoice or invoices from a carrier requesting payment for services rendered upon request of a shipper. For example, method 351 may be performed by IPSP 30 so that IPSP 30 can manage invoices issued to shipper 22. IPSP 30 acquires data necessary to process an invoice generated by carrier 24 that requests payment be made for a shipment requested by shipper 22. Reference is made to carrier 24 and shipper 22 for purposes of explanation of the processes of FIGS. 7-16. Shipper 22 provides 352 IPSP 30 with copies of its shipment contract(s) with a carrier or carriers. In the exemplary embodiment, system 32 determines 354 whether the shipment rates or other rates included in the contracts are valid. Preferably, the verification of the rates is accomplished by entering the rate information into IPSP's database (temporarily) and comparing the rates to valid rates already stored in the database or by checking with a reliable third party source. If the rates are invalid, system 32 requests 356 shipper 22 provide updated rate information. System 32 stores 358 valid rates in database 120 (shown in FIG. 2), for use in further processing 360 of invoices from carrier 24 for shipments on behalf of shipper 22.

System 32 also acquires 362 data regarding a specific shipment from shipper 22, enabling system 32 to create a shipment record. The data is transmitted from shipper 22 in any suitable format, such as EDI, XML or a spreadsheet, such as Excel®. System 32 determines 364 if shipper 22 has provided all necessary data and if the data provided is valid. For example, system 32 compares the shipment data to a shipper profile associated with shipper 22. The shipper profile includes, but is not limited to including, a set of requirements that must be fulfilled prior to payment of an invoice for shipper 22. The set of requirements may include a list of types of data IPSP 30 must receive from shipper 22 before IPSP 30 processes an invoice for shipper 22, such as scheduled shipment departure and arrival dates, origin and destination details, shipment segments, carriers and modes of travel for each segment, details regarding the goods being shipped (nature of the goods, details regarding packaging), special requirements or conditions for the shipment such as special local regulations or laws that apply, etc. If data is missing or provided data is invalid, system 32 rejects 366 the shipping record, prompting direct follow-up contact by IPSP 30 with shipper 22. Once system 32 obtains complete and valid data from shipper 22, system 32 creates and stores 368 a shipping record for use in invoice processing.

System 32 also obtains 370 data regarding that same shipment from carrier 24. Carrier 24 determines 371 whether its shipment data is in electronic or paper form. If the data is already in an electronic format, such as, but not limited to, EDI, XML or a spreadsheet, such as Excel®, carrier 24 transmits 372 the electronic data to IPSP 30. Alternatively, shipper 24 transmits 374 paper invoices to IPSP 30. IPSP 30, in turn, scans 376 the pre-invoices and/or enters 378 the data into its database 120. In the exemplary embodiment, system 20 determines 380 if any data required for processing the invoice is missing or if data provided by carrier 24 is invalid. For example, system 32 determines 380 if the requirements included within the shipper profile have been fulfilled. If data defined as required by the shipper profile associated with shipper 22 has not been provided by carrier 24, and/or if system 32 determines that data provided by carrier 24 is invalid, system 32 prompts carrier 24 and IPSP 30 to collaborate 382 to fulfill data requirements and/or resolve information discrepancies. If system 20 determines 380 that the carrier data is complete and accurate, system 20 proceeds to further process 386 the invoice. In some countries (typically in Europe), data received from either shipper 22 or carrier 24 cannot be used as the “formal” invoice for purposes of payment. In such situations, the electronic data received, while referred to as a “pre-invoice”, is handled by system 32 as an actual invoice for purposes of processing for approval for payment. At the end of processing, IPSP 30 generates a formal invoice, which is transmitted to both shipper 22 and carrier 24, at the time of payment of the invoice.

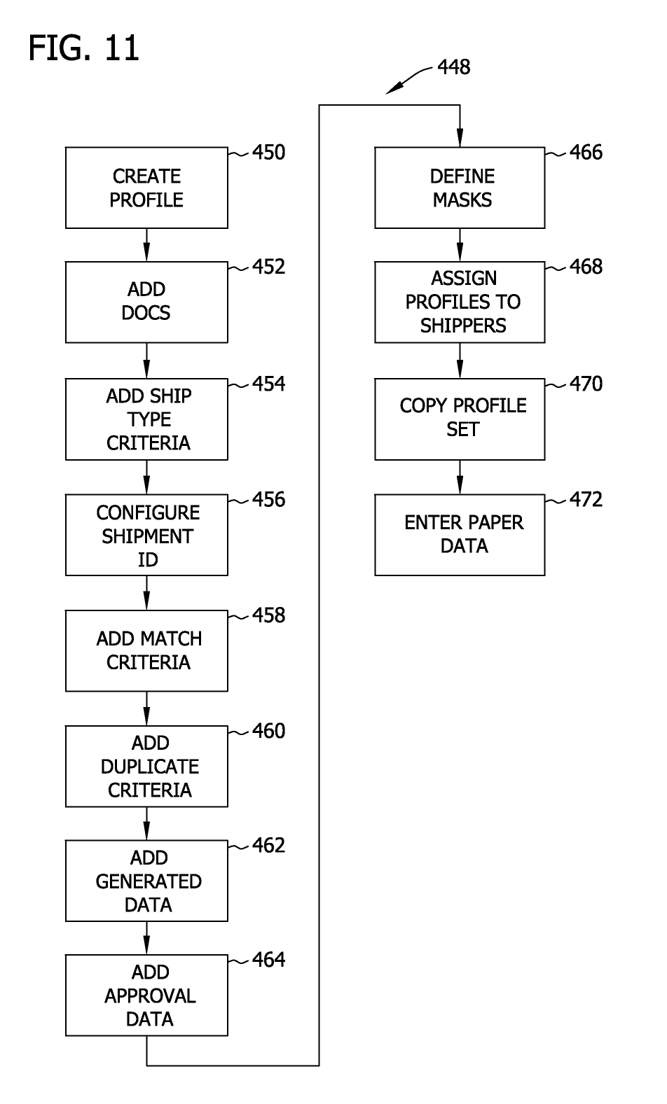

FIG. 11 is a flowchart which illustrates further aspects of method 351 (shown in FIG. 7), and more specifically, the data acquisition and profile creation underlying invoice management process 330 (shown in FIG. 6). In the exemplary embodiment, invoice management process 330 includes creating 450 a profile for a shipper, for example, shipper 22 (shown in FIG. 1). More specifically, IPSP 30 may create 450 a data entry profile for shipper 22 and/or invoice management system 32 may be configured to create 450 the data entry profile. FIG. 11 is a flowchart of an exemplary method 448 system 32 uses to create a profile associated with shipper 22. As noted herein, not all steps shown in FIG. 11 may be applicable for shipper profiles, and depending upon the shipper profile for which data is being added, steps may be added to the process or deleted.

System 32 creates 450, by entry of shipper data by an operator (typically an employee of IPSP 30), a data entry profile of shipper 22. System 32 adds 452 documents to the profile. These documents will be the types of documents (such as a shipment record or an invoice) that are associated with the type of profile being created. In the process of creating/adding 452 a document, several fields representing various criteria are referenced, including, for example, the name of the profile, an assigned document number label, a profile account type (such as whether the account is a MATCHPAY-type account or a non-match account), a description of the profile, shipment types allowed, and international shipment types allowed (such as import-only, export-only or international—meaning entirely outside the United States).

System 32 adds 454 shipment type criteria to the profile. An operator (employee of IPSP 30) fills data fields at this stage, which system 32 uses to provide reference points for logic used to determine a shipment type for a particular shipment record or invoice, such as: 1) whether the actual shipper is a client (of the IPSP), a client's customer, or a client's vendor; 2) the location of the actual shipper; 3) the consignee type; 4) location of the consignee; 5) the carrier code (SCAC); and 6) whether the shipment is inbound, outbound, interfacility, third party, etc.). System 32 then selects 456 a shipment ID (the unique identifier used by a shipper to identify a specific shipment). The operator adds 458 match criteria, such as the shipper name, carrier name, invoice number, etc., if the rules for shipper 22 require the use of match data for purposes of confirming payment for an invoice.

An employee of IPSP 30 then adds 456 duplicate criteria, used for detecting possible duplicate invoices (again, for invoice profiles only). Such duplicate criteria may include identification of time periods over which checking for duplicate invoices will be made, carriers that will be checked (specifically listed or all), specific kinds of invoices that will be checked (separately invoiced, balance due, etc.), where a suspected invoice will be forwarded (to an auditor, or sent to collaboration, as discussed herein), whether to be a duplicate the invoice must be for the same exact amount. A discovered suspected duplicate invoice must match on all selected criteria to be deemed an actual duplicate to a specific invoice being processed.

System 32 adds 462 generated data (such as addresses derived from previously-entered location codes, or general ledger account codes, as discussed herein) to profiles. In this step, criteria are entered into the profile in order to enable various kinds of data to be generated based on the information contained in similar profiles.

The operator adds 464 approval data to a profile. Approval data includes such information as: whether certain invoices can be paid automatically, or whether all invoices require affirmative approval to be paid; whether certain codes (accessorial codes) require approval only if over a defined monetary amount; whether the specified currency requires approval; whether the shipment type requires approval; more specifically, whether import/export/international shipment types require approval; and whether certain documents, if missing, require approval of the invoice. The operator defines 466 masks to be configured for alphanumeric fields in the profile.

System 32 assigns 468 the generated data to a shipper in the system. Once a profile or set of profiles has been created for a specific shipper, an operator may copy 470 a profile set for use for an entire range (as in range of assigned shipper numbers) or group of similarly-situated (in terms of various selected criteria) shippers.

The IPSP database may also contain shipment records obtained from a shipper in electronic form. In an aspect, a client of an IPSP will be able to access its shipment records from the IPSP website to add, update or delete such records.

In the exemplary embodiment, system 20 is configured to accept electronic data in a variety of formats, including but not limited to, EDI, XML and Excel.

An operator of IPSP 30 enters 472 data that is in paper format. Paper invoices are sorted and verified, and the following data initially derived, for processing purposes: shipper code, master carrier code, primary carrier code, pro number (a number assigned by a carrier as a unique identifier for a specific shipment—the counterpart to a shippers shipment ID), document number, barcode, amount invoiced and received date. Once an invoice has been sorted and verified, in the case of global (international) invoices, system 32 may perform screening of the invoices. System 32 preferably batches paper invoices, e.g., global (i.e., non-domestic US) invoices in groups of no more than fifty (50) invoices, to enable multiple operators to enter invoices for the same shipper and carrier. During the entry of data for paper invoices, the entry of certain data may prompt warnings or instructions to the operator, e.g., to move a invoice from one batch to another, to create a profile because no existing profile fits the invoice, to insert missing data, to forward the invoice to collaboration due to no match required by the profile has been found, etc.

The data entry system for an aspect of the invention is profile-driven, as that term is understood in Universal Modeling Language (UML). An operator at IPSP 30, working at a workstation, for example, workstation 134 (shown in FIG. 3) accesses an online or intranet worksite maintained by IPSP 30, and is presented with a webpage, having multiple tabs available for selection, for the entry of data. The operator uses drop-down menus and fill-in boxes, etc., to enter profile data used to generate a shipper profile.

The profiles contain documents to enter and fields highlighted for entry based on shipment type, international data, accessorials and charge type will be created for data entry. Multiple profiles, based on shipping mode and/or carrier may be assigned to a single shipper number. Once created, a set of profiles can then be copied for use with a wide variety of shippers. In addition, fields defined for documents within a profile contain information regarding how to validate data, where to store data, and how to label a specific field for data entry. Address fields are provided to validate against location and customer (shipper)/vendor (e.g., carrier) information to allow the determination of shipment type based on addresses entered.

Match data for a shipper profile is configurable, in that multiple fields are used to determine whether a match exists between shipper data and carrier data for a particular shipment and corresponding invoice. For example, system 32 can check for a match for a pro number to detect a duplicate invoice, based on a specific monetary amount, while an airway invoice number can be checked for repetition, regardless of the monetary amount. Further, system 32 may generate data, such as GL codes (“general ledger” codes—representing various line items that may appear in an invoice and corresponding accounting ledgers) based on other data, such as shipment type and locations, which are input by an IPSP operator. An operator may configure a profile to require collaboration (as described herein) for approval, for all invoices under that profile. Alternatively, an operator may selectively tag invoices for collaboration prior to approval. Once data available to the operator has been entered into the profile, the operator saves and submits the profile to the IPSP's processing system.

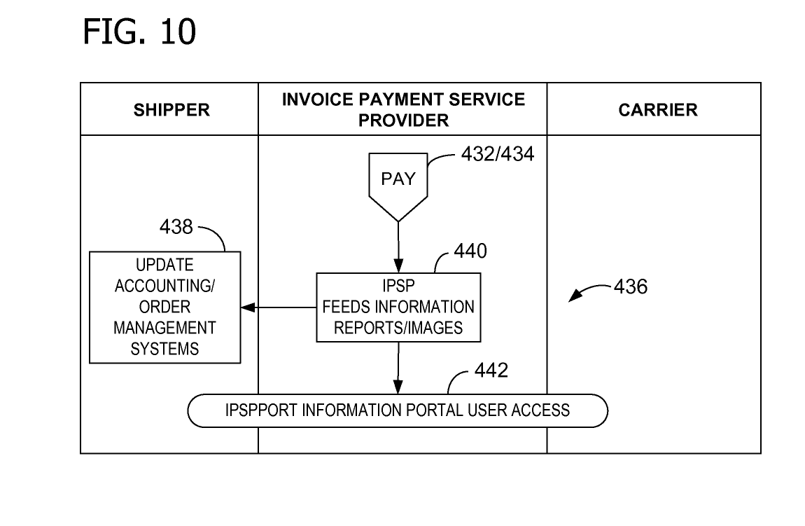

An operator for IPSP 30 enters, tracks and maintains records of the status of each shipment made by carrier 24 on behalf of shipper 22. System 32 generates and makes reports on the acknowledgement of new shipments and the status of shipments in process available to the shipper on a daily basis. The reports include individual shipment record messages for each shipment. This report may be called a Daily Shipment Acknowledgement/Status file, which is a file shipper 22 can access, e.g. at portal 442 (shown in FIG. 10) at the website established by IPSP 30. There will be standard Shipment Record Messages that will be available to all shippers of IPSP 30. These messages will be contained in a standard base Shipment Record Message validation file, and a standard expanded Shipment Record Message validation File. A client-specific expanded Shipment Record Message validation file is provided for expanded messages that are client-specific.

Some shippers of an IPSP require affirmative confirmation of each shipment record that is entered into the IPSP shipment records, which is referred to as Shipment Record Acceptance. In addition, system 32 provides Shipment Record Status validation files that associate an acceptance status with each shipment record message that can be associated with a shipment record for a shipper. A shipment record message simply identifies a shipment or shipments that have occurred or are in process, including a unique identifier (e.g., code) for each shipment, and relevant data such as invoice numbers, origin and destination, etc. The format of the shipment record message may vary from shipper to shipper, according to the shipper's specific instructions or requirements.

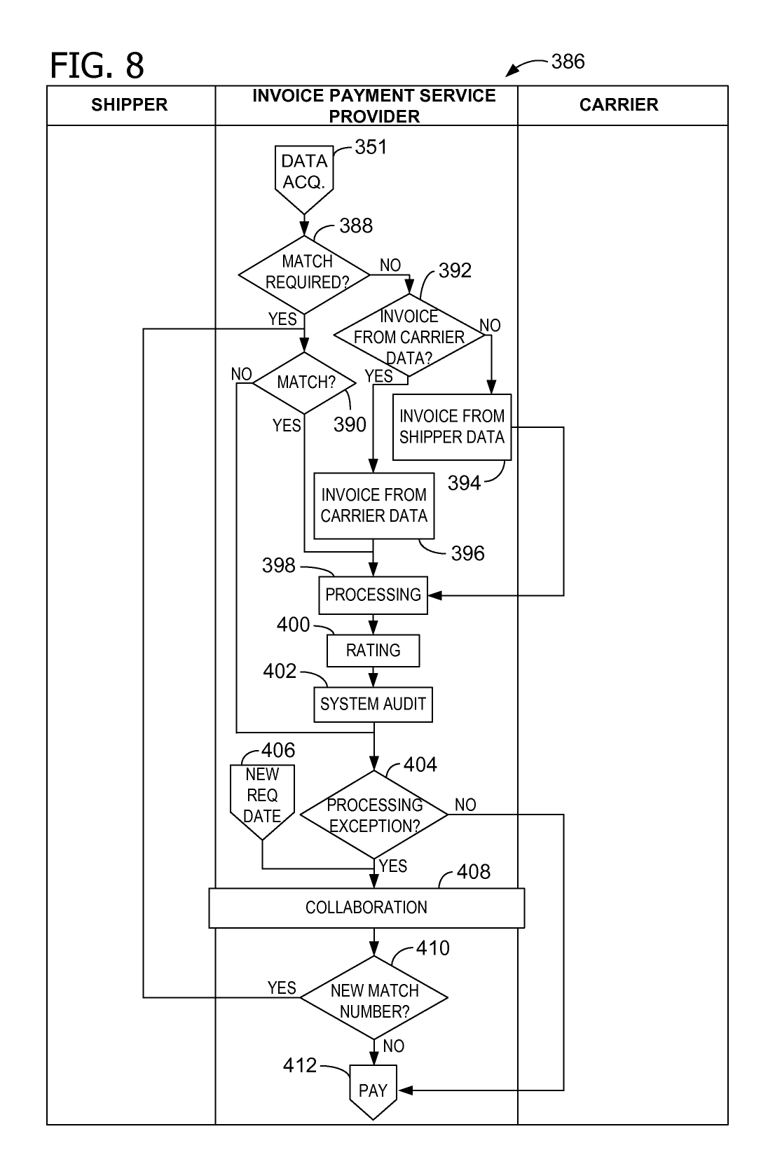

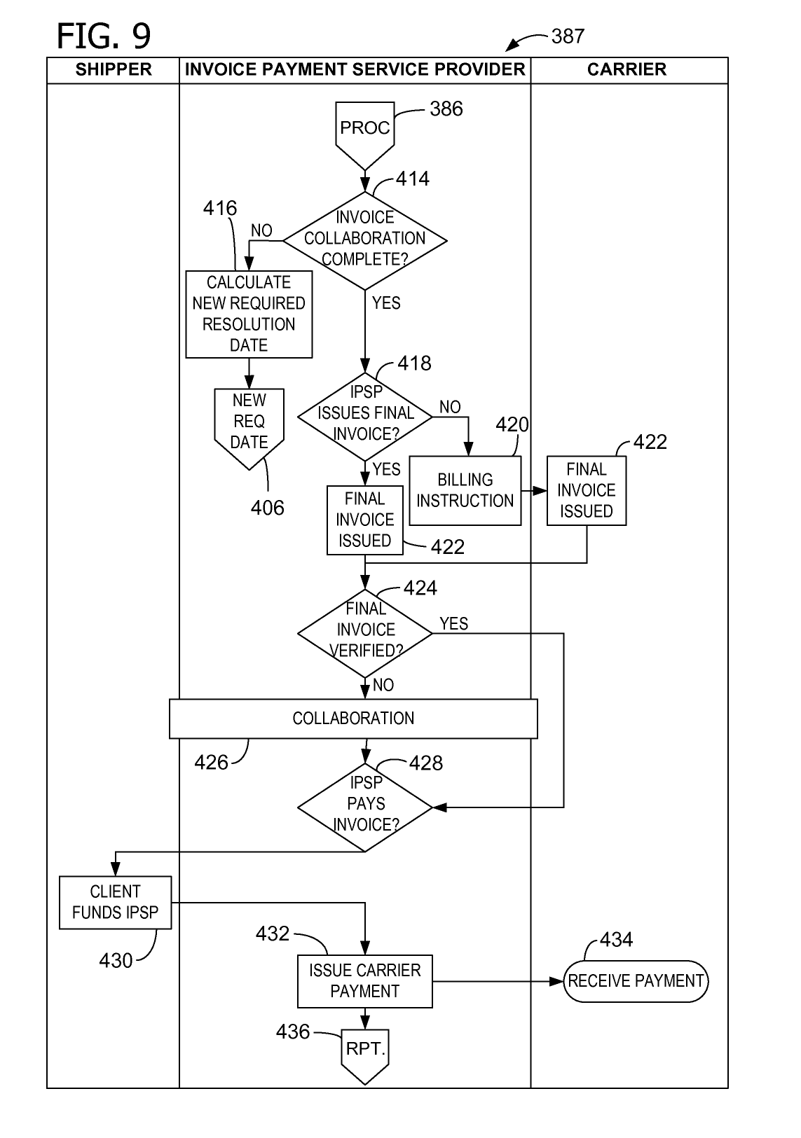

FIG. 8 and FIG. 9 are flowcharts illustrating further steps that may be included in invoice management process 330 (shown in FIG. 6). For example, FIG. 8 is a flow chart of an exemplary method 386 for processing of an invoice for approval, and FIG. 9 is a flowchart of an exemplary method 387 for scheduling and handling actual payment after invoice approval. For example, a requirement may be included within the shipper profile associated with shipper 22 that certain data included within the actual invoice (i.e., invoice provided by carrier 24) match data provided by shipper 22. In the exemplary embodiment, system 32 determines 388 if shipper 22 requires data included within the actual invoice to match data provided by shipper 22. If the shipper profile requires data to match, system 32 also determines 390 if the data required to match, do indeed match. Steps 388 and 390 may be initiated automatically, as part of the programming of infrastructure 100 of system 32. Alternatively, steps 388 and 390 may appear as prompts, with an operator then confirming that those steps be performed.

If shipper 22 does not require a match, system 32 determines 392 whether to generate an invoice based on data acquired from shipper 22 or data acquired from carrier 24. In the exemplary embodiment, the selection as to which data set is used for creating the invoice is controlled by the profile of shipper 22 as a preference added by IPSP 30 during creation of the profile associated with shipper 22. System 32 then generates 396 the invoice from carrier data or generates 394 the invoice from shipper data. Whether there is a match between shipper data and carrier data, or an invoice is generated 396 from carrier data, or an invoice is generated 394 from shipper data, in each case, system 32 processes 398 the resulting invoice. For example, to process 398 the resulting invoice, system 32 may review the invoice for suspected duplicate invoice status, liability checking (checking to determine whether a specific invoice or line item, according to the shipper's profile, simply is not payable by the shipper, for example, according to the terms of the contract between the shipper and the carrier), service verification (determining whether the conditions of the actual shipment, such as overnight delivery, correspond to the previously agreed-to contract terms), or a restriction check (to determine whether there are legal or other restrictions relevant to the particular shipment), among other possible criteria that may require reconciliation before the invoice can be paid. System 32 notes any such variances to a standard invoice on the invoice profile for further review and action during subsequent processing. A standard invoice is one, which includes customary charges and data items, such as: shipper reference number; address and related information regarding the shipper or carrier(s); points of origin and destination; route codes; contracted and actual dates of departure and arrival; transport information (such as the name of a cargo ship); tariff information; information regarding the physical package (such as container codes); equipment codes; standard shipping charges according to mode of transportation; currency information, etc., without atypical additional charges or terms, which may be encountered in an invoice generated from shipper or carrier data.

System 32 then generates 400 a rated invoice and performs 402 an audit of the actual invoice from carrier 24 to the rated invoice. System 32 also includes any discrepancies discovered during the audit in an invoice profile. System 32 compares the amounts of any discrepancies to tolerance preferences included in the shipper profile, and determines whether the discrepancies are within or outside of previously-defined acceptable tolerances. System 32 then determines 404 whether there are any other characteristics of the invoice or underlying shipment which may delay final processing for payment. Likewise, if a match is required between shipper data and carrier data for an invoice, and no match is found, then system 32 determines 404 whether the invoice includes any processing exceptions, such as out-of-tolerance amounts for specific line item charges, etc. If there are no processing exceptions, system 32 begins 412 a payment processing method 387 (see FIG. 9). Furthermore, if there are no processing exceptions, IPSP 30 considers the invoice data to be acceptable to shipper 22 (i.e., the requirements provided by shipper 22 to IPSP 30 that must be fulfilled prior to approval of an invoice have been met). If there are any processing exceptions, then system 32 begins a collaboration process 408, to facilitate resolving match issues, obtaining client approvals (e.g., to override deviations from client preferences), addressing out-of-tolerance problems, etc.

Some shipper profiles may require that once an invoice has passed through collaboration, that the numbers be rechecked for shipper/carrier data match. If so required, system 32 performs 410 a check for shipper carrier data match. If no new match number is required, then system 32 considers the invoice data to be acceptable to shipper 22 and begins 412 payment processing method 387. If a new match number is required, then system 32 returns the invoice to step 390, and performs the shipper/carrier data match check. System 32 then processes the invoice through the subsequent process steps as previously-described.

Referring now to FIG. 9, method 330 includes processing 387 of a payment associated with an approved invoice. In the exemplary embodiment, system 32 determines 414 whether invoice collaboration is complete. If invoice collaboration is not complete, then system 32 determines 416 a new required date for completion of invoice discrepancy resolution. System 32 enters the new data into the invoice file and returns 406 the invoice to collaboration 408 (see FIG. 8) for further processing.

If invoice collaboration 408 (FIG. 8) is complete, system 32 determines 418 whether IPSP 30 is permitted to issue a final invoice, under applicable shipper rules (which may include reference to foreign country law impact, amongst other considerations). If IPSP 30 is not permitted to generate the final invoice, system 32 prompts IPSP 30 to transmit 420 an invoicing instruction to carrier 24. Carrier 24 issues 422 a final invoice based on the invoicing instruction or by selecting specific shipments during collaboration 408 and then uploading a final invoice to IPSP 30. System 32 verifies 424 the final invoice issued by carrier 24. If the final invoice is not verified, system 32 returns the final invoice to collaboration 426. If the final invoice is verified, and, under the terms of the engagement between shipper 22 and IPSP 30, IPSP 30 is authorized 428 to pay carrier 24 directly, then IPSP 30 notifies shipper 22 of the amount required. Shipper 22 transfers 430 the necessary funds to IPSP 30, enabling IPSP 30 to issue payment 432 to carrier 24. In the exemplary embodiment, method 386 includes reporting 436 of completed payments to shipper 22. Typically, reports 436 to shipper 22 are generated on a regular basis and will identify, for example shipments and corresponding invoices that have either completed processing or are at some stage in process, and will include reference to the types of data used to process the invoices, such as shipment ID and pro number.

FIG. 10 is a flow chart of an exemplary method 436 for reporting completed payments to shipper 22. After system 32 confirms payment 432/434 to carrier 24, system 32 collects 440 payment information and updates 438 information stored in accounting/order management systems. System 32 also posts 442 the payment notice to its own database 120, for access by shipper 22 through a user access portal.

FIG. 12 is a flowchart illustrating an exemplary audit processing stage 402 (shown in FIG. 8) of invoice payment process 330 (shown in FIG. 6). In the process shown in FIG. 12, system 32 addresses actual invoices received from carrier 24, to determine the steps necessary to enable payment of those invoices or to identify discrepancies between the actual invoices and rated invoices to identify those actual invoices that require reconciliation and possible collaboration. An operator of system 32 sorts 502 invoices received from carrier 24. There are several invoice types in addition to standard invoices (“standard” meaning any invoice not determined to be in one of the following categories) including:

Separately invoiced accessorial invoices—invoices sent by the carrier to invoice charges that were not included on the original invoice, for example, if the carrier invoices detention charges after the original invoice was sent.

Balance due invoices—invoices sent by the carrier to request payment for invoices where the carrier believes the full amount was not paid for through the original invoice, e.g., where the IPSP cut the amount on the original invoice.

Dynamic linkage invoices—these invoices occur for certain payment accounts in which a single invoice may match multiple shipper data records. This may occur when a carrier has multiple shipments on a single truck, so all shipments were submitted on a single invoice covering all of the bill of lading numbers that were on the truck, but the shipper had transmitted to the IPSP a separate record for each bill of lading number.

Suspected duplicate checking—a suspected duplicate invoice is always to be sent to audit collaboration and will not be processed for payment before then.

Invoices with a suspected denied party—a denied party is an individual, entity or geographic location with whom the United States government has prohibited business. A IPSP may chose not to pay invoices that contain or reference a denied party, in part because the IPSP may be subjected to governmental fines for doing so. Such invoices will always be sent to Audit Collaboration before payment (e.g., to determine whether the reference to the denied party can be legally removed or revised from the invoice).

System 32 determines 504 whether an invoice has been received from a carrier (as identified by its standard carrier alpha code or “SCAC”) for which rating information is not available. If the invoice amount is in excess of a limit which system 32 has pre-defined for non-ratable carriers, system 32 transmits 506 the invoice to Audit Collaboration. If system 32 determines 508 that the invoice is not a non-ratable SCAC over the pre-established limit, system 32 then determines 510 whether pre-established accessorial limits (pre-defined limits on charges other than line-haul charges) affect any rated amounts represented in the invoice. If the accessorial limits affect rated amounts, then system 32 uses 512 limit information for limited accessorial rated amounts, to facilitate further audit processing of the invoice. If system 32 determines 510 that accessorial limits do not affect rated amounts, then system 32 uses 516 invoice rating information to provide data to complete data file fields for unlimited accessorial and linehaul rated amounts in the invoice. System 32 automatically reduces 518 line items in the invoice to rated amounts. System 32 compares 520 the differential between the original invoice amounts for the separate line items, and the rated amounts for those items, to previously-defined tolerances. If system 32 determines that the differentials are outside of tolerance limits, then the invoice is transmitted 506 to Audit Collaboration. If system 32 determines that the differentials are within tolerance limits, then system 32 transmits 524 the invoice to audit collaboration 525. During audit collaboration, an auditor (employee of IPSP 30) reviews the processing of the invoice, and if correct, enters an appropriate notation (e.g., check box) into system 32. System 32 then forwards 526 the invoice to processing for payment. Not all invoices are sent to audit collaboration. For example, if system 32 determines that an invoice, after undergoing audit processing, is ready for payment, system 32 routes the invoice directly to payment processing 386 (FIG. 9) without waiting for audit collaboration by an auditor.

In order to audit invoices, system 32 establishes in database 120 tables of information in the following categories, among possible categories, for the profiles for the respective specific shippers:

Non-Ratable SCACs—representing SCACs for primary carriers for which the IPSP does not have fee rates and the invoices for which a particular shipper does not require/want the IPSP to audit.

Shipper Tolerance Amount—contains positive and negative tolerance amounts to use when comparing a total invoiced amount against the total rated amount of the invoice that has been determined after the invoice goes through payment rating.

Auto-Cut Information—indicates what invoice line items (linehaul or accessorial charges) will be automatically cut from an invoice after payment rating and prior to tolerance checking.

SCAC Mismatch Override—this category indicates those SCACs that should not cause a SCAC mismatch error when the SCAC for the primary carrier in the carrier data record does not match the SCAC in the shipper data record for the invoice.

The foregoing process is applicable to most but not all carrier invoices, the exceptions being invoices which have already been determined, through application of the rules for any specific shipper, not to be payable due to violation of one or more requirements.

In an exemplary embodiment, the invoice payment process described herein includes an audit collaboration stage, for example, audit collaboration 342 (shown in FIG. 6). As discussed with respect to FIG. 12, audit collaboration may occur when system 32 determines 504 that an invoice includes a non-ratable SCAC which is over a pre-defined limit or, after system 32 determines 520 that an invoice includes one or more amounts that differ from rated amount(s) in excess of pre-defined tolerance(s).

In practice, invoices that have been identified during audit processing as requiring audit collaboration are provided to authorized IPSP 30 personnel through an online internet or intranet portal. An auditor of IPSP 30 accesses an audit collaboration screen and, using system 20 and applying specific search criteria, generates a report identifying all invoices matching those search criteria. Relevant search criteria may include invoice type, transportation method, shipper identification, carrier identification, origin, final destination, etc. The search results in a listing of relevant invoices, which the auditor may sort, select and view. Each invoice record shows various characteristics of the invoice, such as the PRO number, the BL number, invoice type (Linehaul, Balance Due, Extra Charges—separately invoiced accessorial charges), ship date, scheduled payment release date, whether the invoice has proceeded through Collaboration 426 (FIG. 9), the reason the invoice was forwarded to Audit Collaboration 408, FIG. 8 (audit exception, suspected duplicate invoice, etc.), and whether the invoice had been worked on in Audit Collaboration 408 previously. Auditors for IPSP 30 may be assigned to specific shippers, so that invoices from a specific shipper are always reviewed by a specific auditor who is or becomes familiar with typical invoices for that shipper, and methods for addressing processing exceptions for invoices for that shipper. Auditors may be provided flexibility in processing invoices that have been marked for audit, sorting them first, typically, by shipper, and then by other factors, such as date, carrier, origin, destination, etc.

Once system 32 identifies an invoice or invoices as requiring Audit Collaboration, those invoices are posted in system 20 in an audit collaboration report, which may be accessed by auditors working for IPSP 30, and which may list invoices that have been posted for audit, and the status of those invoices (e.g., entered, in process, resolved). To resolve an invoice in Audit Collaboration 408 (FIG. 8), an auditor opens an invoice record, identifies information that is missing and/or invalid/incorrect, enters the missing or corrective information, which the auditor obtains directly from the shipper, carrier, etc., inserts comments where appropriate (such as a “cut reason” to explain why a certain amount in a line item in an invoice was cut and/or reduced), validates the entered data, “resolves” the invoice by actuating the appropriate tab or button on the screen, removes that invoice from the audit collaboration report, and proceeds to the next invoice. If a number of invoices all require the same information/data/actions to resolve them, system 20 is suitably programmed to enable a group of like invoices to be resolved simultaneously (for example, by entering in a change to a destination, etc., and by confirming, causing the same changes to be made to several invoices simultaneously).

Audit Collaboration 408 presents a screen or screens (tabbed, etc.) that enable an auditor to view the issues requiring collaboration (information needed, rate discrepancy resolution) and track progress of resolution steps, including tracking the correspondence/dialog history between shipper 22, carrier 24, and/or IPSP 30.

During Audit Collaboration 408 (FIG. 8), an auditor may revise data or input missing data into the system database, specifically the rating facility 336 (FIG. 6) which, in turn, may result in changes to rates derived/developed by that facility (“output report”) which facilitate completion of other data entry fields in the Audit Collaboration stage, toward resolution of a particular invoice or invoices.

Once system 32 has processed an invoice in Audit Collaboration 506 (FIG. 12), system 32 may resolve the invoice by forwarding it to payment. Alternatively, system 32 may resolve an invoice in Audit Collaboration 506 by forwarding it to Collaboration 426 (FIG. 9). In another alternative situation, system 32 may resolve an invoice by placing it “On Hold”.

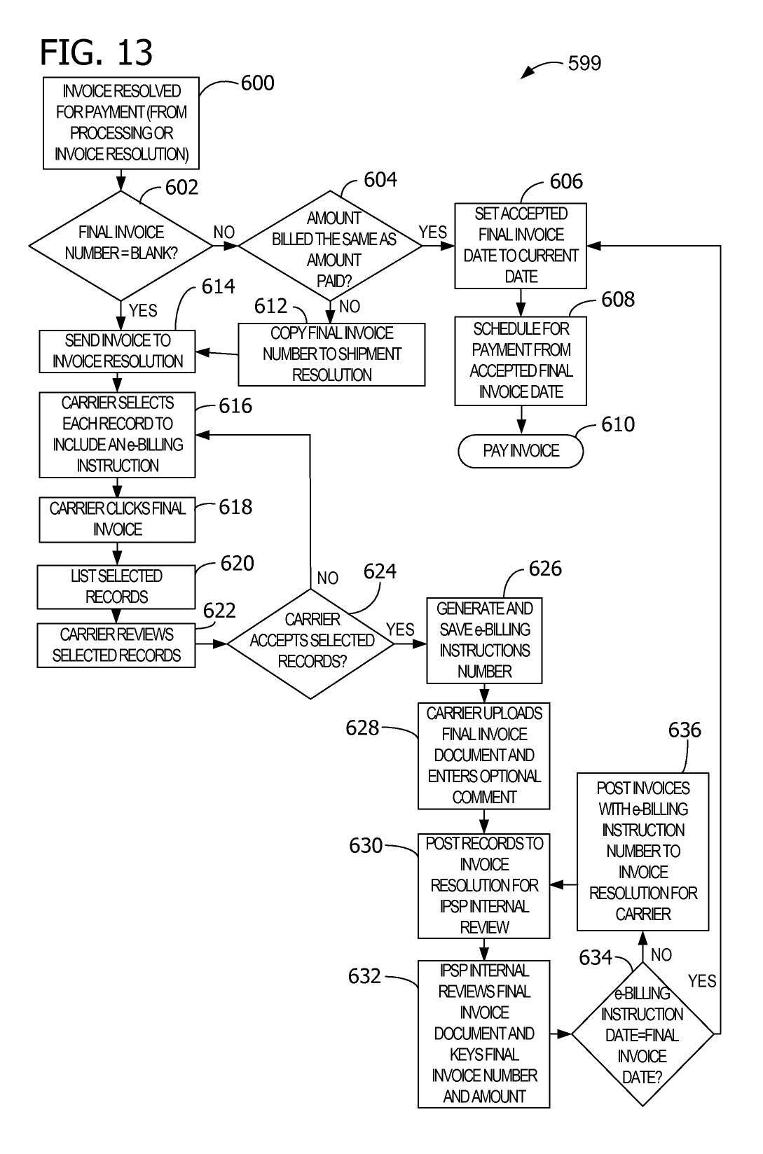

In an aspect, invoice payment process 330 (FIG. 6) of system 20 includes payment processing 387 (FIG. 9), which further incorporates an invoice e-Billing Process stage 599 (FIG. 13). FIG. 13 is a flowchart illustrating an exemplary invoice e-Billing Process final processing stage 599. System 32 receives 600 invoices from standard processing or from invoice resolution (See FIG. 9 and accompanying text). Often, due to various legal requirements in certain countries (such as Mexico, for example), a “final” invoice, bearing a final invoice number, must be presented or created by the carrier to the shipper (or the shipper's proxy), in order for that invoice to be paid. In the example just given, of a shipment in, from, or to Mexico, the final invoice is referred to as a “factura”. Accordingly, system 32 checks 602 an invoice received from standard processing or invoice resolution to determine whether the invoice has a final invoice number. If there is a final invoice number assigned, then system 32 compares 604 the invoice submitted by the carrier to the invoice amounts that have resulted from the invoice processing, to determine whether the amount of the invoice is the same as the amount which has been determined to be the correct amount to be paid. If the amounts agree, then system 32 establishes 606 the then-current date as an accepted final invoice date, schedules the invoice 608 for payment and pays 610 the invoice. If the amounts checked at 604 are not in agreement, then system 32 forwards 612 the final invoice to shipment resolution (?) and subsequently forwards the invoice 614 to Invoice Collaboration and Resolution (FIG. 16 and associated text). Likewise, system 32 determines 602 that the invoice does not have an assigned final invoice number, system 32 forwards the invoice 614 to Invoice Resolution.

At this point, IPSP 30 contacts carrier 24 that issued the invoice to select 616, through the IPSP portal facility 442, each line item that carrier 24 wishes to have included in a final invoice. Carrier 24 selects 618 a “final invoice” option and lists 620 on the page displayed (or select from a pre-generated list) the line item records it wishes to include in the final invoice, reviews 622 those records, and chooses 624 whether to accept those records. If the carrier does not accept all the records, system 32 returns the proposed final invoice to selection step 616, until an acceptable group of records is achieved. System 32 generates and saves 626 an e-billing instructions number. Carrier 24 then uploads 628 to system 20 a final invoice document, with any additional comments. System 32 posts 630 the final invoice document to a file identified as Invoice Resolution for internal review by IPSP 30 personnel. If, after internal review, system 32 does not identify any unresolved issues, then an operator of IPSP 30 enters 632 the final invoice number and amount into system 20. If system 32 determines 634 that the e-billing instruction data and the “final” invoice data match, system 32 returns the invoice 606 to establish the then-current date as the final invoice date, for subsequent processing and payment at steps 608 and 610 as previously described. If, however, system 32 determines that the e-billing instruction data and the final invoice data are not in agreement, then system 32 forwards 636 the invoice, with the e-billing instruction number, to Invoice Resolution and notifies the carrier that further input and review by the carrier is needed.

As described in the preceding paragraphs, Invoice Resolution is a sub-process which can occur, or be brought into action, at several locations throughout the invoice payment process (see, e.g., steps 614, 636 described with relation to FIG. 13). FIG. 16 is a flowchart illustrating an exemplary procedure 342 for addressing an invoice which system 32 has identified as requiring invoice collaboration and resolution. System 32 determines 801, at some stage (e.g., 615, 636 of FIG. 9) that an invoice requires resolution. Specifically, FIG. 16 illustrates various points along the invoice management process at which resolution (and possible collaboration with parties outside of IPSP 30) is required. It is anticipated that while most invoices may not include any processing exceptions that will require resolution, on occasion, invoices will contain one or more exceptions (such as one or more dollar amounts being outside of pre-defined tolerances). However, it is unlikely that a single invoice will contain numerous exceptions. Accordingly, while FIG. 16 illustrates many locations where collaboration may take place, it is anticipated that not all collaborative steps will be required for any specific invoice.

Once system 32 has identified that an invoice (and its corresponding shipment(s)) require resolution, system 32 determines whether the shipper profile (not shown) for shipper 22 requires a match between shipper data and carrier data for a specific shipment for an invoice to be approved for payment. If the shipper profile for shipper 22 does not require a match, system 32 determines 806 whether the invoice contains any amounts that exceed pre-defined tolerances, and whether the shipper profile requires approval if any out-of-tolerance amounts exist. If the shipper profile dictates that no approval of out-of-tolerance amounts is required, system 32 then determines whether the shipper profile requires a final invoice to be entered into the shipper profile for shipper 22. If system 32 determines that no final invoice is required, system 32 forwards 599 (FIG. 13) the invoice for further processing and payment.

If the shipper profile indicates that approval (typically by IPSP 30 personnel, based on criteria provided by the shipper's profile) for out-of-tolerance amounts is needed, system 32 determines 814 whether or not to reject the shipment and corresponding invoice. An invoice may be rejected, for example, because of the presence in the invoice of out-of-tolerance amounts for which the shipper's profile does not permit discretion on the part of IPSP 30 to approve. If system 32 determines not to reject the shipment, IPSP 30 personnel review the invoice and either accept or modify 818 specific invoice dollar amount entries. System 32 determines 820 whether either the shipper profile or data regarding the carrier requires that carrier 24 must approve of any modifications to the invoice. If carrier approval is required, and carrier 24 accepts 822 the modifications, the invoice is returned to step 806. The out-of-tolerance amounts having been either accepted by IPSP30 or modified to be within tolerance, system 32 treats the invoice as not requiring approval for out-of-tolerance amounts and determines 828 whether a final invoice is required, as previously described.

If system 32 determines 820 that approval by carrier 24, for any modifications made by IPSP 30 to the invoice, is not required, system 32 then determines 824 whether approval is required by shipper 22 for any such modifications. If approval is required, system 32 prompts 826 shipper 22 to accept or modify any amounts in the invoice, enabling system 32 to return the invoice to processing for a determination 806 if out-of-tolerance approval is needed, If system 32 determines that shipper approval is not needed for modifications to the invoice, system 32 likewise returns the invoice to processing for determination 806 for out-of-tolerance amounts in the invoice.

Returning to step 802, if system 32 determines that the shipper profile for shipper 22 requires a match between shipper 22 data and carrier 24 data for that shipment, system 32 then determines 804 whether such a match exists or not. If a match exists, system 32 determines 810 from the shipper profile whether or not the shipment is complete and whether or not any other issues exist preventing the invoice from being forwarded for payment processing, or whether the invoice is payable. If, according to the shipper profile record of that shipment, the invoice is payable, system 32 checks 806 for out-of-tolerance amounts, as previously described. If system 32 determines that the invoice is not payable, IPSP 30 is prompted to contact the shipper to address any unresolved issues addressable by shipper 22. If the issues are resolved, preferably within a pre-defined time period, system 32 returns the invoice to the process for determination 804 whether the shipment matches the shipper profile record. If system 32 determines 812 that the shipper profile record issues have not been resolved, system 32 prompts 808 shipper 22 to enter new match number(s)/data to enable the invoice to be returned for determination 804 as to whether the invoice and the shipper profile record match.

If system 32 determines to reject the shipment and invoice, system 32 informs 816 carrier 24 that the shipment and invoice have been rejected, providing, in the rejection notice, the reason(s) why the invoice was rejected for payment. The carrier must then submit a new, preferably revised invoice for re-processing.

Returning to determination 828, if system 828 determines that the shipper profile requires a final invoice for payment, system 32 contacts carrier 24. Carrier 24, accessing the relevant shipment files via the user portal maintained by IPSP 30, selects and groups 830 data for multiple shipments to assemble a final invoice, and uploads 832 the final invoice into database 120. If system 32 determines 834 that additional information, such as value added tax (VAT), is required for the final invoice, system 32 prompts carrier 24 to additionally upload 836 that information as well. System 32 checks the invoice and determines 838 whether the final invoice is valid. If the final invoice is not valid, system 32 prompts 840 carrier 24 to review and revise the invoice, and re-upload it. If system 32 determines that the invoice is valid, system 32 forwards 599 the invoice for further processing.

In an aspect, the invoice payment process 330 (FIG. 6) using system 20 includes a rating facility 636, during which, for a specified shipment file record (origin, destination, size, weight, number of items, nature of items, etc.), a “correct” rated invoice can be generated, and compared to the actual invoice presented by the carrier, to determine whether the actual invoice agrees with the rated invoice or not.

Rating facility 636 employs a rating program for accessing internal or external databases for determining what appropriate shipping costs should be, for a shipment having certain defined characteristics. One such known program is known as Ratemaker®, which is a proprietary program developed, owned and operated by Cass Information Systems, of St. Louis, Mo.

IPSP 30 receives data from shipper 22, to create rating profiles containing data fields that are used in the ratemaking facility program. Fields that are required for rating an invoice include such as ship date, loaded and empty distance, shipment mode, commodities shipped, shipment conditions, route, accessorial charges, numbers of trailers, rail cars or shipment containers used, etc. The fields are configured to access data from a specified field in a specified database table, or the fields may be configured to apply certain common data to all invoices or specified groups of invoices. For example, “CL” as a value may be used to indicate the origin, destination, and stop off information may be defined as a city, state, and country). As previously described, several different profiles may be applicable to a single shipper, depending upon such characteristics as whether the shipper has multiple divisions, uses different modes of transportation (air, sea, rail, road), etc. A set of profiles can then be copied to a range of shippers, with certain data being modified to correspond to a specific shipper (such as shipper name, address, etc.).

Before system 32 can rate an invoice, system 32 checks invoices for shipper-specific requirements, such as stale ship date (e.g., ship date older than 90 days). Regardless of whether an invoice passes or fails the shipper-specific checks, system 32 creates rating facility input records based on the rating profile. The records in a rating facility input file will contain the information required to rate an invoice.

System 32 performs three types of rating for a single invoice: Accrual rating; Payment rating; and Best Rate rating. Accrual rating is performed for MATCHPAY accounts, when a shipper data record is received, the shipper data record is rated to determine the shipper's liability for the shipper data records received (explain). Accrual rating does not perform auto-cutting of invoices or check invoices for in- or out-of-tolerance status. After IPSP 30 personnel input carrier invoice data into database 120, an individual invoice is rated for payment. If a matching shipper data record has already been accrual rated, the carrier data will still be rated. This will address potential accrual rating errors or address changes that occur after accrual rating, to ensure that the invoice is rated against the most recent available rating information. Best Rate rating is an optional step that acquires rates for all carriers for the requested mode of shipment. This enables IPSP to identify the most favorable rate, and transmits that information to the shipper in a report.

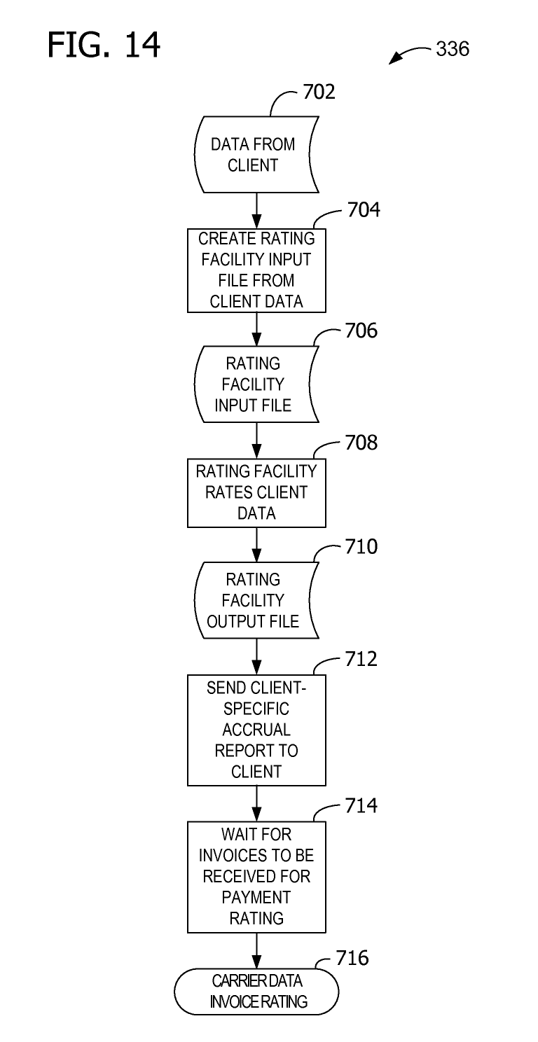

As mentioned above, with respect to the overall process 330 of FIG. 6, part of the overall process involves rating an invoice, to determine what a specific shipment, under specific conditions, “should” cost. FIG. 14 is a flowchart illustrating an accrual rating stage 336 (FIG. 6) for invoice payment system 20. “Accrual rating” refers to invoices created by system 32, based on data received from shipper 22, which rated invoices are later used to compare to data received from carrier 24 in a matching process, to determine whether the invoices are ready for payment, or require further processing. System 32 receives 702 data from shipper 22. An operator at IPSP 30 creates 704 a rating facility input file from shipper data, and inputs it into database 120. The rating facility applies 708 shipper data to create 710 rating facility output file. System 32 compiles rating facility output file 710 into a shipper-specific accrual report sent 712 to the shipper. IPSP 30 receives invoices 714 from shipper 22. Upon receipt of shipment data from carrier 24, system 32 rates 716 carrier data-derived invoices, for possible future comparison with shipper data.

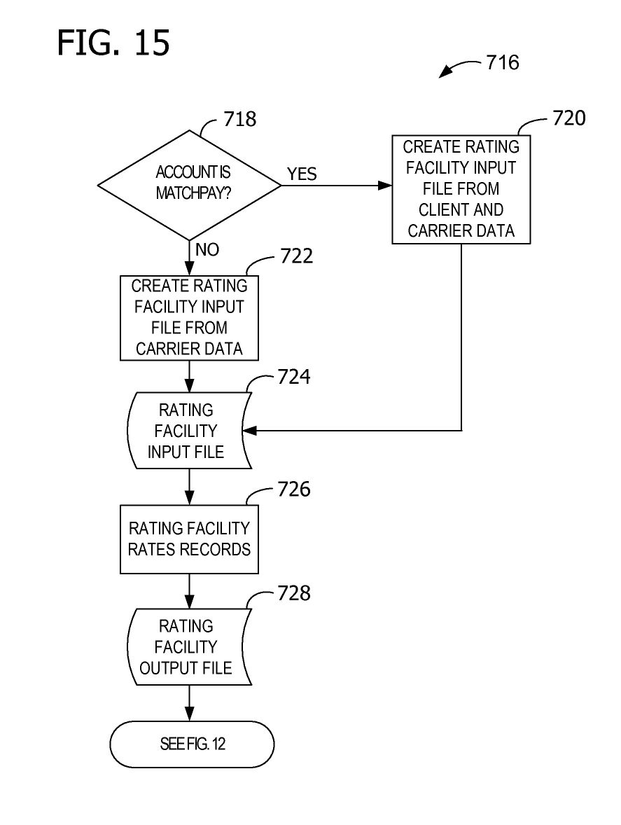

FIG. 15 is a flowchart illustrating the carrier data invoice rating process 716 (from FIG. 14). First, system 32 determines 718 whether the shipper account to which the invoice applies is a MATCHPAY-type account, in which case system 32 creates 720 a rating facility input file from both shipper and carrier data. If the shipper account is not a MATCHPAY-type account, then system 32 creates 724 the rating facility input file solely from carrier data. In each situation, system 32 uses 726 the rating facility input file to rate the invoice records to create 728 the rating facility output file. Once the invoice has been rated, system 32 forwards 730 the invoice rating records to auditing (described with respect to FIG. 12 herein).

The systems and methods are not limited to the specific embodiments described herein. In addition, components of each system and each method can be practiced independent and separate from other components and methods described herein. Each component and method also can be used in combination with other components and processes.

The methods and systems described herein facilitate efficient and economical payment of invoices from carriers for shipments carried out on behalf of shippers. Exemplary embodiments of methods and systems are described and/or illustrated herein in detail. The methods and systems are not limited to the specific embodiments described herein, but rather, components of each system, as well as steps of each method, may be utilized independently and separately from other components and steps described herein. Each component, and each method step, can also be used in combination with other components and/or method steps.

When introducing elements/components/etc. of the methods and systems described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer based method for processing and paying invoices from one or more carriers by an invoice payment service provider on behalf of a shipper, said method implemented using a computer device coupled to a memory device, wherein the computer device and the memory device are associated with the invoice payment service provider, said method comprising:
creating at the computer device at least one data profile based on data provided by at least one of the shipper, the carrier and the invoice payment service provider wherein the data provided by at least one of the shipper, the carrier and the invoice payment service provider comprises country-specific data representing requirements regulating shipping;
creating at the computer device a rating for a specified shipment of goods based at least partially on the at least one data profile, the rating representing an optimized set of one or more charges for the specified shipment of goods;
receiving an actual invoice corresponding to the specified shipment of goods from the carrier;
comparing at the computer device the rating to data included within the actual invoice for the specified shipment of goods; and
identifying with the computer device whether any discrepancies exist between the rating and the data included within the actual invoice;
authorizing by the computer device payment if all identified discrepancies are within predetermined limits;
if one or more identified discrepancies are outside of predetermined limits, determining, in accordance with one or more rules contained within the at least one data profile, whether to perform one of reject the actual invoice, modify the actual invoice with approval of at least one of the shipper and the carrier, and modify the actual invoice without approval of at least one of the shipper and the carrier.

2. A computer based method in accordance with claim 1, further comprising:
providing a web-based access interface to enable at least one of a shipper, a carrier and an invoice payment service provider to upload data into and download information from a web-based invoice payment service system.

3. A computer based method in accordance with claim 1, further comprising:
processing the invoice for payment, following resolution of the identified discrepancies.

4. A computer based method in accordance with claim 1, further comprising:
processing the invoice for payment, if no discrepancies are identified.

5. A computer based method in accordance with claim 1, wherein the at least one data profile is a shipper profile.

6. A computer based method in accordance with claim 1, wherein the data provided by at least one of the shipper, the carrier and the invoice payment service provider further comprises data representing commodities being shipped.

7. A computer based method in accordance with claim 1, wherein the data provided by at least one of the shipper, the carrier and the invoice payment service provider further comprises data representing at least one mode of transport employed for a specified shipment.

8. A computer based method in accordance with claim 1, wherein the data provided by at least one of the shipper, the carrier and the invoice payment service provider further comprises data representing shipper-specific requirements that must be met to enable the invoice payment service provider to authorize payment of an invoice.

9. A computer based method in accordance with claim 1, wherein creating, with data provided by at least one of the shipper, the carrier and the invoice payment service provider, at least one data profile comprises:
assembling a set of rules that contain criteria which must be met in order for an invoice to be approved for payment.

10. A computer based method in accordance with claim 1, further comprising:
identifying missing information required to create one of the at least one data profile and the rating; and
requesting the missing information.

11. A system for processing and paying invoices from one or more carriers by an invoice payment service provider on behalf of a shipper, said system comprising:
a database configured to store data associated with at least one of a shipper, a carrier and the invoice payment service provider;
a database server; and
one or more computers;
the database, database server, and one or more computers being associated with the invoice payment service provider and configured to:
create at least one data profile based on data provided by at least one of a shipper, one or more carriers and an invoice payment service provider wherein the data provided by at least one of a shipper, one or more carriers and an invoice payment service provider comprises country-specific data representing requirements regulating shipping;
create a rating for a specified shipment of goods, the rating representing an optimized set of one or more charges for the specified shipment of goods;
receive an actual invoice corresponding to the specified shipment of goods from the carrier;
compare the rating to data included within the actual invoice for the specified shipment of goods; and
identify whether any discrepancies exist between the rating and the data included within the actual invoice;
authorize payment if all identified discrepancies are within predetermined limits; and
if one or more discrepancies are outside of predetermined limits, determine in accordance with one or more rules contained within the at least one data profile whether to perform one of reject the actual invoice, modify the actual invoice with approval of at least one of the shipper and the carrier, and modify the actual invoice without approval of at least one of the shipper and the carrier.

12. A system in accordance with claim 11, further comprising:
a web-based access interface to enable at least one of the shipper, the carrier and the invoice payment service provider to upload data into and download information from the database;

13. A system in accordance with claim 11, further comprising:
the database, database server, and one or more computers being further configured to:
process the invoice for payment, following resolution of the identified discrepancies.

14. A system in accordance with claim 11, further comprising:
the database, database server, and one or more computers being further configured to:
processing the invoice for payment, if no discrepancies are identified.

15. A system in accordance with claim 11, wherein the at least one data profile is a shipper profile.

16. A system in accordance with claim 11, wherein the data provided by at least one of the shipper, the carrier and the invoice payment service provider further comprises data representing commodities being shipped.

17. A system in accordance with claim 11, wherein the data provided by at least one of the shipper, the carrier and the invoice payment service provider further comprises data representing at least one mode of transport employed for a specified shipment.

18. A system in accordance with claim 11, wherein the data provided by at least one of the shipper, the carrier and the invoice payment service provider further comprises data representing shipper-specific requirements that must be met to enable the invoice payment service provider to authorize payment of an invoice.

19. A system in accordance with claim 11, wherein the data provided by at least one of the shipper, the carrier and the invoice payment service provider comprises country-specific data directed to legal requirements regulating shipping.

20. A system in accordance with claim 11, further comprising:
the database, database server, and one or more computers being further configured to:
identify missing information required to create one of the at least one data profile and the rating; and
request the missing information.

21. A computer device for processing and paying invoices from one or more carriers by an invoice payment service provider on behalf of a shipper, the computer device being associated with the invoice payment service provider and programmed to:
create at least one data profile based on data provided by at least one of the shipper, the carrier and the invoice payment service provider wherein the data provided by at least one of the shipper, the carrier and the invoice payment service provider comprises country-specific data representing requirements regulating shipping;
create a rating for a specified shipment of goods based at least partially on the at least one data profile, the rating representing an optimized set of one or more charges for the specified shipment of goods;
receive an actual invoice corresponding to the specified shipment of goods from the carrier;
compare the rating to data included within the actual invoice for the specified shipment of goods; and
identify whether any discrepancies exist between the rating and the data included within the actual invoice;
authorize payment if all identified discrepancies are within predetermined limits; and
if one or more discrepancies are outside of predetermined limits, determine in accordance with one or more rules contained within the at least one data profile whether to perform one of reject the actual invoice, modify the actual invoice with approval of at least one of the shipper and the carrier, and modify the actual invoice without approval of at least one of the shipper and the carrier.

22. A computer device in accordance with claim 21, further configured to:
provide a web-based access interface to enable at least one of a shipper, a carrier and an invoice payment service provider to upload data into and download information from a web-based invoice payment service system;

23. A computer device in accordance with claim 21, further configured to:
process the invoice for payment, following resolution of the identified discrepancies.

24. A computer device in accordance with claim 21, further configured to:
process the invoice for payment, if no discrepancies are identified.

25. A computer device in accordance with claim 21, wherein the at least one data profile is a shipper profile.

26. A computer device in accordance with claim 21, wherein the data provided by at least one of the shipper, the carrier and the invoice payment service provider further comprises data representing commodities being shipped.

27. A computer device in accordance with claim 21, wherein the data provided by at least one of the shipper, the carrier and the invoice payment service provider further comprises data representing at least one mode of transport employed for a specified shipment.

28. A computer device in accordance with claim 21, wherein the data provided by at least one of the shipper, the carrier and the invoice payment service provider further comprises data representing shipper-specific requirements that must be met to enable the invoice payment service provider to authorize payment of an invoice.

29. A computer device in accordance with claim 21, wherein the at least one data profile comprises:
a set of rules that contain criteria which must be met in order for an invoice to be approved for payment.

30. A computer device in accordance with claim 21, further configured to:
identify missing information required to create one of the at least one data profile and the rating; and
request the missing information.
